(19) United States
(12) Patent Application Publication
(10) Pub. No.: US 2008/0122303 A1
(43) Pub. Date: May 29, 2008

(54) DIRECT-CURRENT MOTOR AND MANUFACTURING METHOD FOR THE DIRECT-CURRENT MOTOR

(75) Inventors: Shinji Santo, Kosai-shi (JP); Masayuki Kuwano, Kosai-shi (JP)

Correspondence Address: AKERMAN SENTERFITT, P.O. BOX 3188, WEST PALM BEACH, FL, 33402-3188, US

(73) Assignee: ASMO Co., Ltd., Kosai-shi (JP)

(21) Appl. No.: 11/928,874

(22) Filed: Oct. 30, 2007

(30) Foreign Application Priority Data
Nov. 7, 2006 (JP) 2006-301861
Oct. 22, 2007 (JP) 2007-273792

(51) Int. Cl. H02K 23/04; H02K 15/03; H02K 5/16; H02K 5/24; H02K 1/17; H02K 13/04; H02K 23/20

(52) U.S. Cl. 310/51; 29/597; 29/598; 310/233; 310/89; 310/91; 310/154.01; 310/242; 310/249

(57) ABSTRACT

A direct-current motor includes a stator having a magnetic field system, a rotor disposed around the stator, a commutator which rotates together with the rotor, and power supply brushes which are urged in the axial direction by urging members so as to come into contact with the sliding contact surfaces. The rotor includes an armature core around which armature coils are wound, and a rotary shaft which rotates together with the armature core. The commutator has segments extending radially. The segments have sliding contact surfaces orthogonal to an axial line of the rotary shaft. At least a part of each power supply brush comes into contact with the sliding contact surface at a position further radially outward than the armature coil.

### BACKGROUND OF THE INVENTION

The present invention relates to a direct-current motor and a manufacturing method for the direct-current motor.

Japanese Laid-Open Patent Publication No. 06-261502 discloses a direct-current motor having armature coils disposed on an outer periphery of a magnetic field system is described. This direct-current motor includes a stator having a permanent magnet forming a magnetic field system, and a rotor having a plurality of armature coils which are disposed on the outer periphery of the stator and rotate integrally with the rotary shaft. This rotor has no armature core around which the armature coils are wound, so that the rotor is light in weight. Therefore, by pivotally supporting the rotary shaft by a bearing, the rotor is prevented from becoming unsteady when rotating.

To effectively utilize the magnetic fluxes of the armature coils, if the rotor described in Japanese Laid-Open Patent Publication No. 06-261502 is provided with an armature core, the mass of the rotor increases according to the armature core. In this case, when the rotor slightly vibrates while rotating, it is difficult to suppress this vibration, or this vibration increases. To suppress the vibration of the rotor, a bearing made more rigid may be used, however, this results in an increase in size of the bearing.

### SUMMARY OF THE INVENTION

An objective of the present invention is to provide a direct-current motor of an outer rotor type having an armature core in a rotor, which motor is capable of suppressing vibration of the rotor.

In order to achieve the above-described object, according to a first aspect of the present invention, a direct-current motor including a stator having a magnetic field system, a rotor disposed around the stator, a commutator which rotates together with the rotor, and a plurality of power supply brushes is provided. The rotor includes an armature core around which armature coils are wound, and a rotary shaft which rotates together with the armature core. The commutator has a plurality of segments extending radially, and the segments have sliding contact surfaces orthogonal to an axial line of the rotary shaft. The power supply brushes are urged in the axial direction by urging members so as to come into contact with the sliding contact surfaces. At least a part of each power supply brush comes into contact with the sliding contact surface at a position further radially outward than the armature coil.

In accordance with a second aspect of the present invention, a manufacturing method for a direct-current motor having a stator having a magnetic field system, a rotor disposed around the stator, a commutator which rotates together with the rotor, and a plurality of power supply brushes is provided. The rotor includes an armature core around which armature coils are wound, and a rotary shaft which rotates together with the armature core. The commutator has a plurality of segments extending radially, and the segments have sliding contact surfaces orthogonal to an axial line of the rotary shaft. The power supply brushes are urged in the axial direction by urging members so as to come into contact with the sliding contact surfaces. The method includes: disposing the power supply brushes at further radially outer positions than the magnetic field system such that the power supply brushes are urged in the axial direction by the urging members; fixing the armature core around which the armature coils are wound to the inside of a cylindrical rotor housing having a bottom portion; fixing the rotary shaft to the bottom portion of the rotor housing; fixing the commutator to an opening of the rotor housing such that the sliding contact surfaces are directed in a direction opposite to the armature coils; and assembling the rotor and the stator to each other by moving one of the rotor and the stator with respect to the other along the axial direction and inserting the magnetic field system into the inside of the rotor housing from the opening of the rotor housing, such that at least a part of each power supply brush comes into contact with the sliding contact surface at a position further radially outward than the armature coils.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a cross-sectional view of a direct-current motor, and FIG. 1B is a partially enlarged cross-sectional view of the direct-current motor;

FIG. 2 is an exploded cross-sectional view of the direct-current motor of FIGS. 1A and 1B;

FIG. 3 is an exploded perspective view of the direct-current motor of FIGS. 1A and 1B;

FIG. 4 is a plan view of segments of the direct-current motor of FIGS. 1A and 1B;

FIG. 5 is a plan view of a commutator of the direct-current motor of FIGS. 1A and 1B;

FIG. 6 is a connection diagram of the direct-current motor of FIGS. 1A and 1B;

FIG. 7 is an exploded perspective view of a direct-current motor of a second embodiment;

FIG. 8 is an exploded perspective view of a brush assembly of the direct-current motor of FIG. 7;

FIG. 9 is a plan view of a stator of the direct-current motor of FIG. 7;

FIG. 10 is a partially enlarged perspective view of the brush assembly of the direct-current motor of FIG. 7;

FIG. 11 is an exploded perspective view of a stator of a direct-current motor of a third embodiment;

FIG. 12 is an exploded perspective view of a brush assembly of the direct-current motor of FIG. 11;

FIG. 13 is a partially enlarged perspective view of the stator of the direct-current motor of FIG. 11;

FIG. 14 is an explanatory view describing the relationship between a commutator and the brush assembly of the direct-current motor of FIG. 11;

FIG. 15 is a perspective view of a stator of a direct-current motor of a fourth embodiment;

FIG. 16 is a side view of a field assembly of the direct-current motor of FIG. 15;

FIG. 17 is a plan view of the stator of the direct-current motor of FIG. 15;

FIG. 18A is an exploded perspective view of a brush assembly of a direct-current motor of another embodiment;

FIG. 18B is a partially enlarged view of FIG. 18A;

FIG. 19 is a perspective view of a brush assembly of a direct-current motor of still another embodiment; and

FIG. 20 is a plan view of segments of a direct-current motor of still another embodiment.

### DESCRIPTION OF PREFERRED EMBODIMENTS

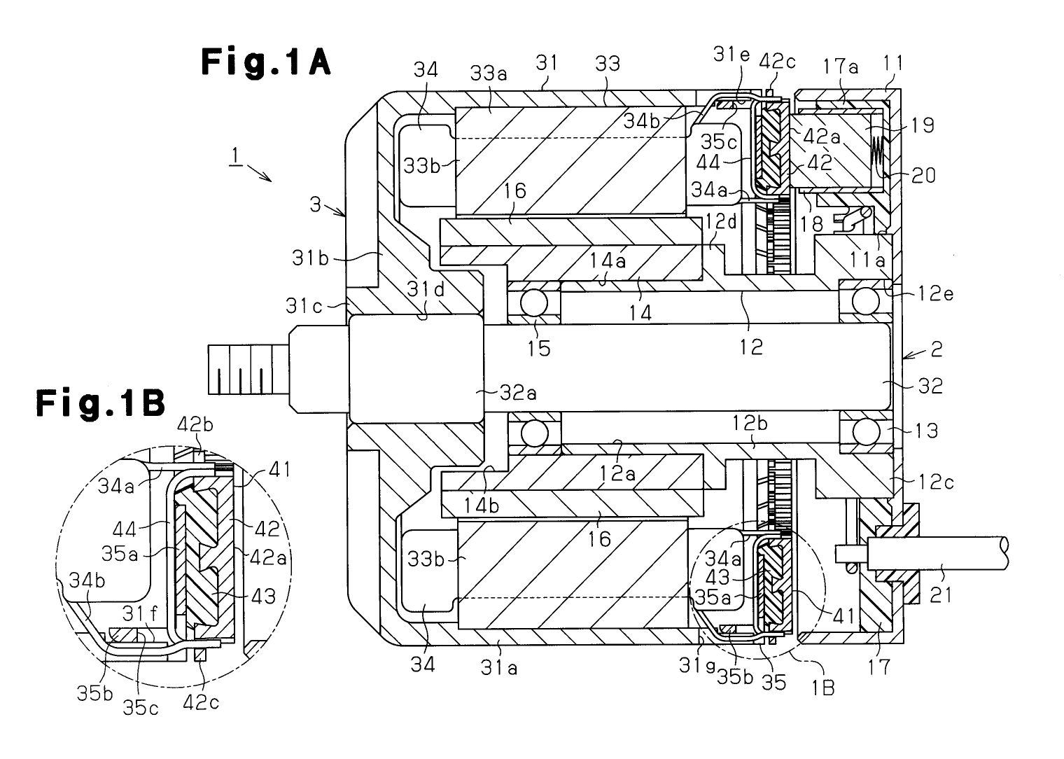

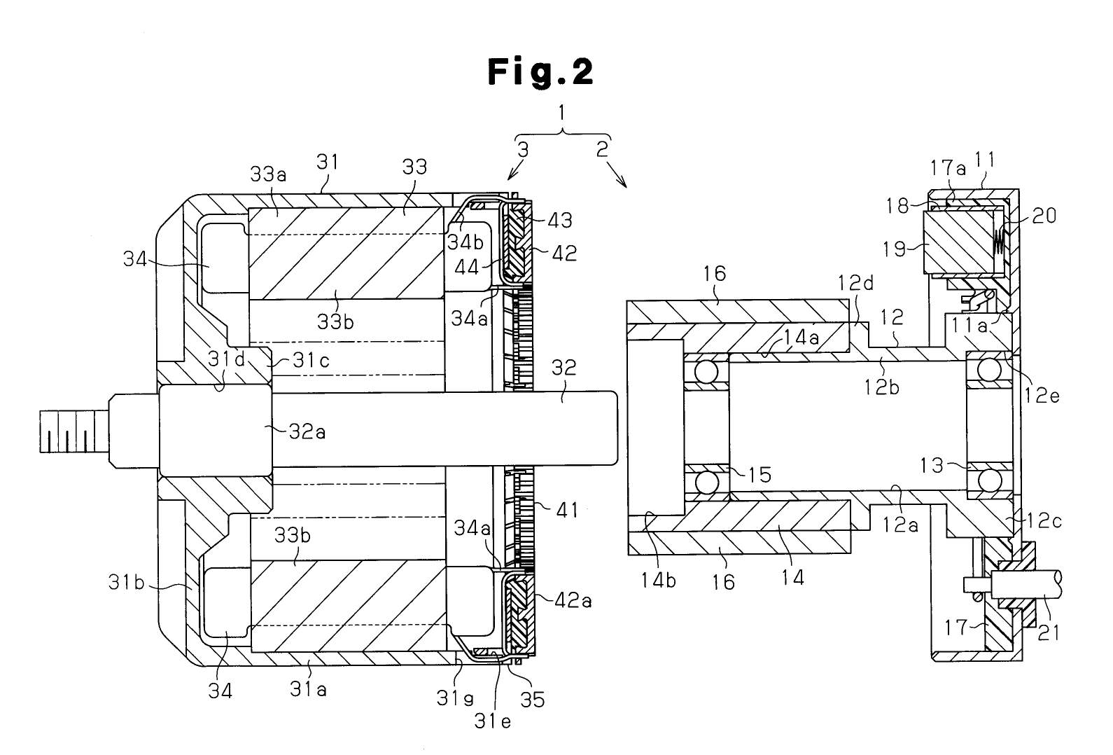

Hereinafter, a first embodiment of the present invention will be described with reference to the drawings. FIG. 1A shows a direct-current motor 1 of this embodiment. As shown in FIG. 2, the direct-current motor 1 includes a stator 2 and a rotor 3 to be assembled to the stator 2.

As shown in FIG. 1A and FIG. 2, a stator housing 11 constituting the stator 2 is in a circular dish shape. On the bottom of the stator housing 11, a ring-shaped protruding ridge 11a protruding toward an opening side of the stator housing 11 is formed. This protruding ridge 11a is concentric with the bottom of the stator housing 11. A support member 12 is disposed on the inner side of the protruding ridge 11a.

The support member 12 includes a cylindrical main body 12b having an insertion hole 12a perforating axially through a radially central portion, a bearing holder 12c formed integrally on an end of the main body 12b close to the stator housing 11, and a flange 12d protruding radially outward from the substantially central portion in the axial direction of the main body 12b.

The main body 12b has an outer diameter smaller than the inner diameter of the protruding ridge 11a. The bearing holder 12c is formed thicker than the main body 12b, and its outer diameter is equal to the inner diameter of the protruding ridge 11a. The bearing holder 12c has, at its radially central portion, a bearing holding hole 12e having a diameter slightly larger than that of the insertion hole 12a. Inside the bearing holding hole 12e, a bearing 13 is housed. The support member 12 is positioned radially with respect to the stator housing 11 by disposing the bearing holder 12c inside the protruding ridge 11a.

In the main body 12b, on an outer periphery of a portion more axially distant from the bearing holder 12c than the flange 12d, that is, a portion more leftward than the flange 12d in FIG. 1A and FIG. 2, a substantially cylindrical field core 14 is disposed. The axial length of the field core 14 is longer than the length from the flange 12d to the distal end in the main body 12b, that is, the length from the flange 12d to the end face on the opposite side of the bearing holder 12c, and the inner diameter of the field core is substantially equal to the outer diameter of the main body 12b. The field core 14 is fixed to the support member 12 by inserting the main body 12b into a fixing hole 14a perforating axially through the field core 14 until the end face closer to the stator housing 11 comes into contact with the flange 12d. Inside the fixing hole 14a, a bearing 15 that comes into contact with the end face opposite to the bearing holder 12c and is paired with the bearing 13 is inserted. On the end of the field core 14 on the opposite side of the flange 12d, an insertion recess 14b having an inner diameter larger than the diameter of the fixing hole 14a is provided. To the outer peripheral surface of the field core 14, a plurality of permanent magnets 16 are fixed so that the N poles and S poles are alternate with each other along the peripheral direction. In this embodiment, eight permanent magnets 16 are fixed to the outer peripheral surface of the field core 14.

On the outer periphery of the bearing holder 12c, a holding plate 17 to be fixed to the bottom of the stator housing 11 is disposed, and on the holding plate 17, a plurality of brush holding tubes 17a in rectangular shapes (only one is illustrated in FIG. 1A and FIG. 2) are formed. The brush holding tubes 17a are formed at positions at predetermined angular intervals in the circumferential direction. Inside each brush holding tube 17a, a brush holder 18 in the shape of a rectangular tube is fixed. Inside each brush holder 18, a power supply brush 19 in substantially a rectangular prism shape is inserted. The power supply brush 19 is urged toward the opening of the brush holding tube 17a by a compression coil spring 20 disposed on the bottom surface of the brush holding tube 17a, and the urging direction of the power supply brush 19 by the coil spring 20 coincides with the axial direction of the main body 12b. The power supply brushes 19 are electrically connected to lead wires 21 drawn out from the stator housing 11. These lead wires 21 are connected to a power source device (not shown).

A rotor housing 31 constituting the rotor 3 integrally includes a cylindrical core fixing portion 31a and a bottom portion 31b which closes one end of the core fixing portion 31a. The rotor housing 31 has a bottomed cylindrical shape as a whole. The core fixing portion 31a has an outer diameter equal to the outer diameter of the stator housing 11, and at the central portion of the bottom portion 31b, a support 31c is integrally provided. The length along the axial direction of the support 31c is larger than the thickness of the bottom portion 31b, and the support 31c protrudes to the outside and the inside of the bottom portion 31b along the axial direction. In the radially central portion of the support 31c, a press-fitting hole 31d perforating in the axial direction is formed.

The support 31c supports a rotary shaft 32 such that the rotary shaft 32 rotates integrally with the support 31c. Further frontward than the axially central portion, that is, at the output side (left side in FIG. 1A and FIG. 2) of the rotary shaft 32, a press-fitting part 32a having an outer diameter larger than other portions of the rotary shaft 32 is fixed. The support 31c is fixed to the rotor housing 31 by press-fitting the press-fitting part 32a into the press-fitting hole 31d of the support 31c.

On the end of the core fixing portion 31a on the opposite side of the bottom portion 31b, that is, on the opening 31e of the rotor housing 31, an engagement fixing portion 31f with an inner diameter larger than the axially central portion of the core fixing portion 31a is provided as shown in FIG. 1B. As shown in FIG. 1A, on the end of the core fixing portion 31a on the opposite side of the bottom portion 31b, a plurality of notches 31g notched from the opening end to the bottom portion 31b are formed at equal angular intervals in the circumferential direction. In this embodiment, thirty-two notches 31g are formed.

As shown in FIG. 1A and FIG. 2, to the inner peripheral surface of the core fixing portion 31a, an armature core 33 is fixed. The armature core 33 includes a cylindrical joint 33a having an outer diameter substantially equal to the inner diameter of the core fixing portion 31a and a plurality of teeth 33b extending radially from the inner peripheral surface of the joint 33a. The armature core 33 is in a substantially ring shape. The armature core 33 of this embodiment has thirty-two teeth 33b. To this armature core 33, an insulator (not shown) that has insulation and covers the portion of the armature core 33 except for the inner peripheral surface and the outer peripheral surface is assembled from both sides in the axial direction. Conductive wires are around the teeth 33b from above the insulator by way of distributed winding. A plurality of armature coils 34 are formed by the conductive wires. The armature core 33 is press-fitted and fixed into the core fixing portion 31a in a state that the armature coils 34 are wound around. In this embodiment, the ends 34a and 34b of each armature coil 34, that is, the winding start end and the winding terminal end of each armature coil 34 are drawn out from the opening 31e of the rotor housing 31.

To the opening 31e of the rotor housing 31, a commutator 41 is fixed via a fixing member 35. The commutator 41 includes thirty-two segments 42 disposed radially, a holder 43 which holds these segments 42, and short-circuit lines 44 which short-circuit predetermined segments 42 to each other. The holder 43 is made of an insulating resin material.

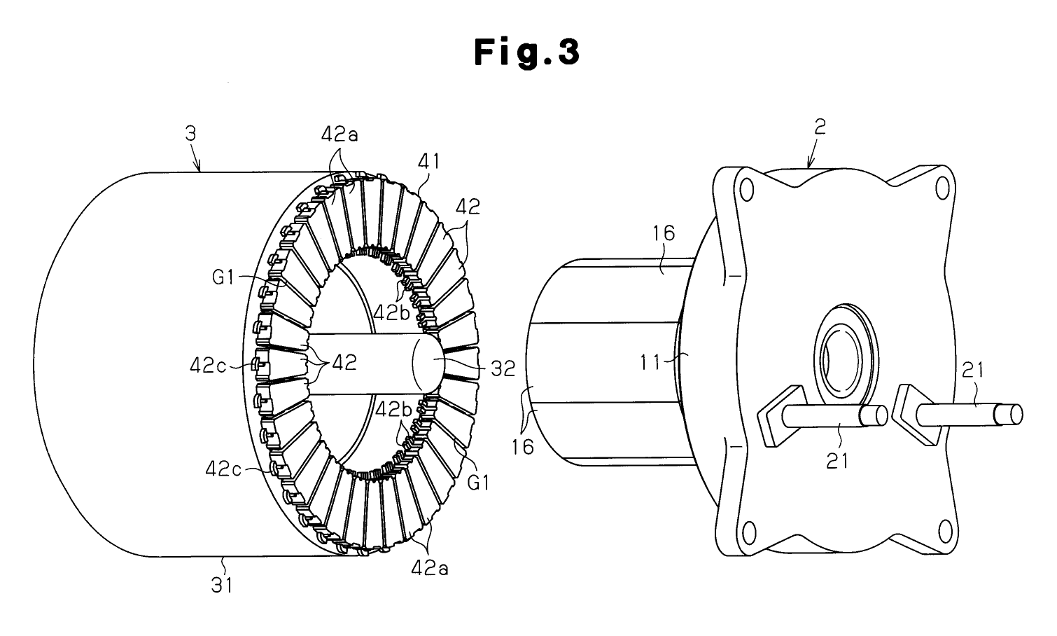

As shown in FIG. 3, a shape of each segment 42 viewed axially is a substantially sectoral shape whose circumferential width widens toward the outer periphery. One axial end face (opposite to the armature core 33) of each segment 42 is a flat sliding contact surface 42a with which the power supply brush 19 is brought into sliding contact. At the end on the axially inside of each segment 42, a pair of inner peripheral connecting pins 42b arranged in the circumferential direction are formed. At the end on the axially outside of each segment 42, an outer peripheral connecting pin 42c that protrudes radially outward and is bent circumferentially is formed.

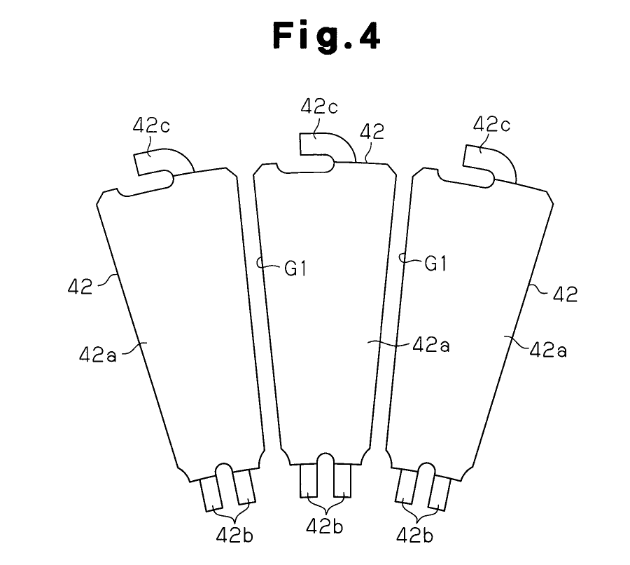

Thirty-two segments 42 are arranged at equal angular intervals in the circumferential direction so that the sliding contact surfaces 42a of the segments 42 are flush with each other, and a gap G1 is formed between segments 42 circumferentially adjacent to each other. In this embodiment, as shown in FIG. 4, the circumferential width of the gap G1 between segments 42 circumferentially adjacent to each other is constant at any radial position. FIG. 4 shows three segments 42 among the thirty-two segments 42.

As shown in FIG. 1A, the holder 43 is in a ring shape, and holds integrally the thirty-two segments 42 disposed circumferentially so that the sliding contact surfaces 42a of the thirty-two segments 42 are flush with each other. The diameter of a circle passing through the radially inner ends of the thirty-two segments 42 held by the holder 43, that is, the inner diameter of the commutator 41 is larger than the outer diameter of the permanent magnets 16 disposed circumferentially. The diameter of a circle passing through the radially outer ends of the thirty-two segments 42 held by the holder 43, that is, the outer diameter of the commutator 41 is equal to the outer diameter of the rotor housing 31.

The fixing member 35 includes a holder fixing portion 35a formed like a ring-shaped plate and a housing fixing portion 35b extending axially from the peripheral edge on the radially outside of the holder fixing portion 35a. In this fixing member 35, thirty-two insertion holes 35c are formed at equal angular intervals circumferentially. The outer periphery of the housing fixing portion 35b is equal to or slightly larger than the inner diameter of the engagement fixing portion 31f provided on the opening 31e of the rotor housing 31. By fixing the holder fixing portion 35a onto a surface of the holder 43 on the opposite side of the segment 42, the fixing member 35 is fixed to the commutator 41. In the state that the fixing member 35 is fixed to the commutator 41, the circumferentially central portions of the segments 42 and the insertion holes 35c coincide with each other in the circumferential direction.

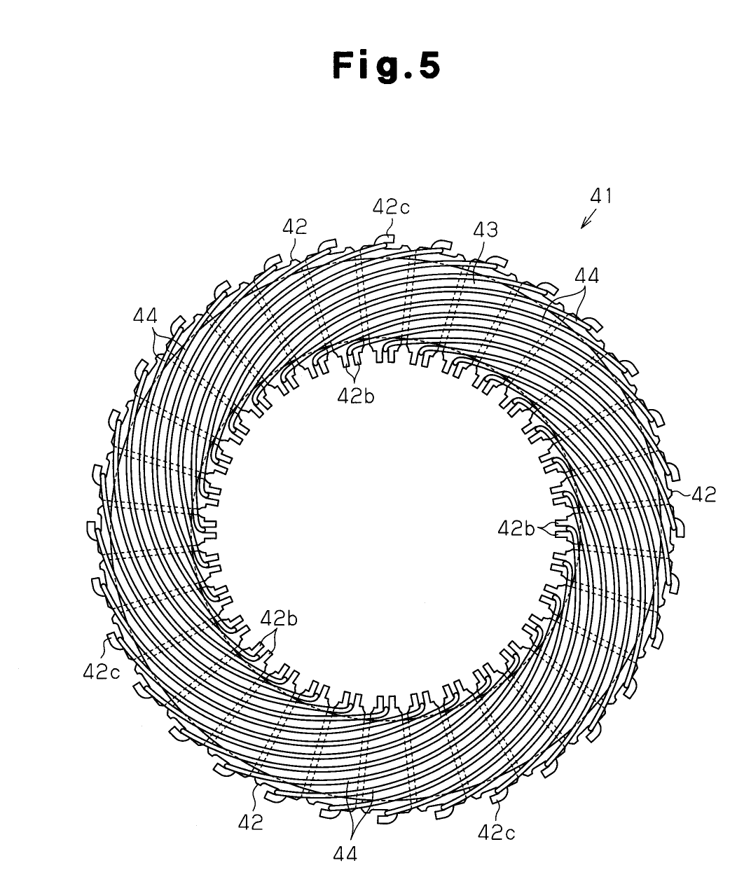

FIG. 5 is a plan view of the commutator 41. In FIG. 5, the fixing member 35 is omitted. As shown in FIG. 5, to make the potentials of predetermined segments 42 equal to each other, one end of each short-circuit line 44 is connected between the corresponding pair of inner peripheral connecting pins 42b, and the other end is connected to the outer peripheral end of the segment 42 by the corresponding outer peripheral connecting pin 42c. In detail, each short-circuit line 44 passes above the holder fixing portion 35a from the inner peripheral connecting pins 42b of one segment 42 of two segments 42 and passes through the insertion hole 35c positioned on the radially outside of the other segment 42 and extends to the outer peripheral connecting pin 42c of the other segment 42 (see FIG. 1B). In this embodiment, by electrically connecting every eighth segment in the circumferential direction to each other by the short-circuit lines 44, the segments 42 at every 90° are made equal in potential.

As shown in FIG. 1A, the commutator 41 is fixed to the opening 31e of the rotor housing 31 via the fixing member 35 by assembling the housing fixing portion 35b into the engagement fixing portion 31f so that the thirty-two insertion holes 35c and the thirty-two notches 31g formed in the opening 31e of the rotor housing 31 coincide with each other in the circumferential direction.

The sliding contact surfaces 42a of the commutator 41 are arranged to face toward the opposite side of the armature core 33 (armature coils 34). The thickness direction of the commutator 41 coincides with the axial direction, and its sliding contact surfaces 42a are orthogonal to the axial direction. The sliding contact surfaces 42a of the segments 42 extend further radially outward than the armature coils 34.

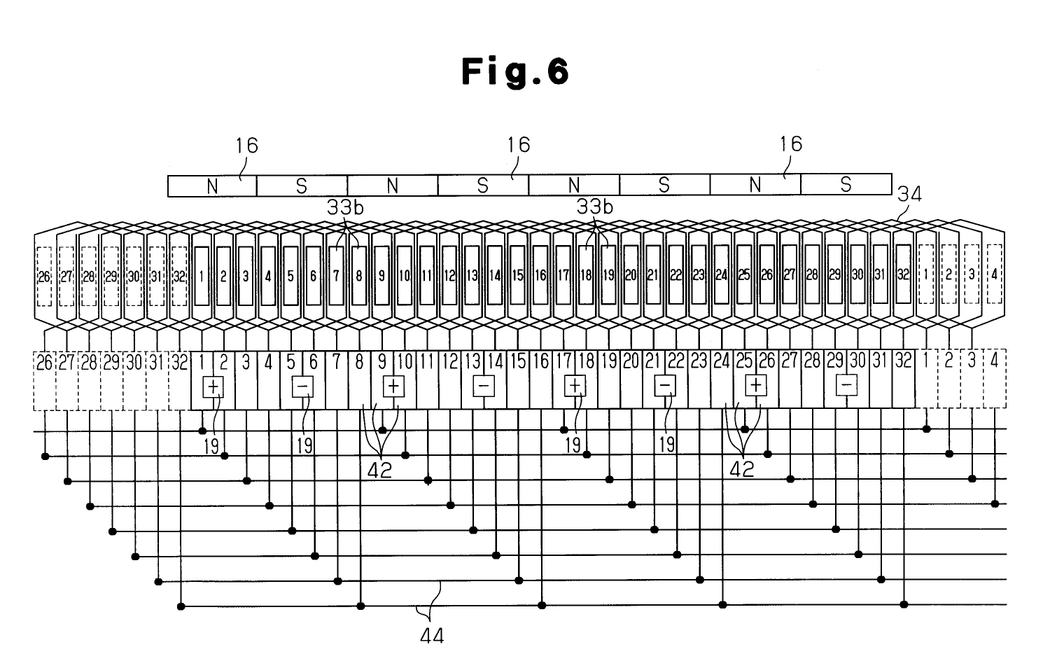

To the segment 42 of the commutator 41, ends 34a and 34b of the corresponding armature coil 34 are electrically connected. In detail, in each armature coil 34, the end 34a drawn from the radially inside is connected to the radially inner end of the corresponding segment 42, that is, between the inner peripheral connecting pins 42b, and the end 34b drawn out from the radially outside is connected to the radially outer end of the corresponding segment 42 via the outer peripheral connecting pin 42c. The end 34b of the armature coil 34 is drawn out to the outside of the rotor housing 31 from the notch 31g formed in the opening 31e of the rotor housing 31 and then connected to the radially outer end of the corresponding segment 42 by the outer peripheral connecting pin 42c. As shown in FIG. 6, by connecting the ends 34a and 34b of the armature coil 34 to the corresponding segment 42, the ends 34a and 34b of the predetermined armature coil 34 are short-circuited via the commutator 41.

The stator 2 and the rotor 3 are assembled to each other by inserting the rotary shaft 32 of the rotor 3 into the insertion hole 12a of the support member 12 through the insertion recess 14b provided in the field core 14 of the stator 2. In the state that the stator 2 and the rotor 3 are assembled to each other, the rotary shaft 32 is pivotally supported by a pair of bearings 13 and 15, and on the outer periphery of the permanent magnets 16, an armature core 33 is disposed. With the sliding contact surfaces 42a of the segments 42 constituting the commutator 41, the distal end faces of the power supply brushes 19 (left end faces in FIG. 1A) come into contact, and the distal end faces of the power supply brushes 19 are in contact with the sliding contact surfaces 42a at the further radially outward than the armature coils 34. In the support 31c, a portion protruding to the inside of the rotor housing 31 is inserted into the insertion recess 14b formed in the field core 14.

In the direct-current motor 1 constructed as described above, when a current is supplied to the armature coils 34 via the power supply brushes 19, the rotor 3 rotates with respect to the stator 2 in response to a rotating magnetic field generated in the rotor 3. According to the rotation of the rotor 3, the commutator 41 also rotates, so that the segments 42 to be brought into sliding contact with the power supply brushes 19 are changed, and the armature coils 34 are successively commutated.

Next, a manufacturing method for the direct-current motor 1 will be described. The direct-current motor 1 of this embodiment is manufactured through a stator assembling step, a rotor assembling step, and a motor assembling step.

At the stator assembling step, as shown in FIG. 2, the support member 12, to which the field core 14, the permanent magnets 16, and the bearings 13 and 15 are assembled, is assembled with the stator housing 11, and the power supply brushes 19 are assembled, whereby the stator 2 is manufactured. At this time, the power supply brushes 19 are inserted into the brush holders 18 disposed on the further radially outer side of the stator housing 11 than the permanent magnets 16 along the axial direction of the support member 12. By manufacturing the stator 2 according to this step, the positional relationship between the permanent magnets 16 and the power supply brushes 19 with respect to the radial direction of the stator housing 11 is determined. In the manufactured stator 2, this positional relationship is kept constant.

At the rotor assembling step, by press-fitting the armature core 33 around which armature coils 34 are wound into the inside of the rotor housing 31, the armature core 33 is fixed to the rotor housing 31. On the opening 31e of the rotor housing 31, the commutator 41 is fixed to the fixing member 35 so that the sliding contact surfaces 42a are arranged to face toward the opposite side of the armature coils 34. By press-fitting the press-fitting part 32a of the rotary shaft 32 into the press-fitting hole 31d of the support 31c, the rotary shaft 32 is fixed to the bottom portion 31b. Therefore, the rotor housing 31 and the rotary shaft 32 become rotatable integrally. Both ends 34a and 34b of the armature coils 34 are electrically connected to the radially inner ends and radially outer ends of the corresponding segments 42. The stator assembling step and the rotor assembling step may be performed concurrently. Alternatively, either one of the assembling steps may be performed first.

After finishing the stator assembling step and the rotor assembling step, the stator 2 and the rotor 3 are assembled to each other at the motor assembling step. At the motor assembling step, the stator 2 and the rotor 3 are relatively moved along the axial direction of the rotary shaft 32 in the state that the opening of the stator housing 11 and the opening 31e of the rotor housing 31 face each other. Accordingly, the end of the rotary shaft 32 of the rotor housing 31 that corresponds to the opening 31e is inserted into the insertion hole 12a from the insertion recess 14b of the support member 12 of the stator 2, and the rotary shaft 32 is pivotally supported by the bearings 13 and 15. Simultaneously, the permanent magnets 16 are inserted into the armature core 33 through the inside of the commutator 41, and the portion of the support 31c protruding to the inside of the rotor housing 31 is inserted into the inside of the insertion recess 14b. Then, at the same time as when the stator 2 and the rotor 3 are relatively moved along the axial direction until the rotary shaft 32 is pivotally supported by the bearings 13 and 15, the distal end faces of the power supply brushes 19 come into contact with the sliding contact surfaces 42a of the segments 42 constituting the commutator 41.

Next, advantages of the above-described embodiment will be described as follows.

(1) The sliding contact surfaces 42a of the segments 42 constituting the commutator 41 extend further radially outward than the armature coils 4. The power supply brushes 19 are urged in the axial direction of the rotary shaft 32 by the coil springs 20 and brought into contact with the sliding contact surfaces 42a. According to such a contact of the power supply brushes 19 with the commutator 41 at positions further radially outward than the armature coils 34, vibration of the rotor 3 when the rotor 3 rotates is effectively suppressed. As a result, vibration of the rotor 3 is suppressed without increasing the sizes of the bearings 13 and 15.

(2) Since the rotary shaft 32 is supported by the cylindrical support 31c, the contact area between the rotary shaft 32 and the support 31c is large. As a result, the rotor housing 31 firmly supports the rotary shaft 32. By housing the portion of the support 31c protruding to the inside of the rotor housing 31 into the insertion recess 14b provided in the field core 14, the increase in size in the axial direction of the direct-current motor due to provision of the support 31c and reduction in size in the axial direction of the permanent magnets 16 disposed on the outer periphery of the field core 14 are suppressed.

For example, when the support 31c of this embodiment is entirely protruded to the outside of the rotor housing 31 without changing its length, and the axial length of the rotor 3 is not changed, the axial length of the core fixing portion 31a becomes short. As a result, the armature core 33 is downsized in the axial direction, and the output of the direct-current motor becomes low. However, as in the case of this embodiment, a part of the support 31c protrudes to the inside of the rotor housing 31 and the portion of the support 31c protruding to the inside of the rotor housing 31 is housed inside the insertion recess 14b provided in the field core 14, whereby downsizing of the armature core 33 is suppressed and lowering in output of the direct-current motor 1 is suppressed.

(3) At the stator assembling step, the power supply brushes 19 are arranged so as to be urged axially by the coil springs 20, and at the rotor assembling step, the commutator 41 is fixed to the opening 31e of the rotor housing 31 so that the sliding contact surfaces 42a are arranged to face toward the opposite side of the armature coils 34. At the motor assembling step, when the stator 2 and the rotor 3 are relatively moved along the axial direction of the rotary shaft 32 and the permanent magnets 16 are inserted into the inside of the rotor housing 31 from the opening 31e of the rotor housing 31, the power supply brushes 19 are brought into contact with the sliding contact surfaces 42a of the segments 42 constituting the commutator 41. Therefore, assembly in the manufacture of the direct-current motor 1 is easily performed.

(4) Since the inner diameter of the commutator 41 is larger than the outer diameter of the permanent magnets 16, at the motor assembling step, the permanent magnets 16 are easily inserted into the inside of the armature core 33 through the inside of the commutator 41. As a result, the stator 2 and the rotor 3 are easily assembled.

(5) The power supply brushes 19 are urged in the axial direction of the rotary shaft 32 by coil springs 20, and are inserted into the brush holders 18 along the axial direction. The stator 2 and the rotor 3 are relatively moved along the axial direction of the rotary shaft 32 and assembled to each other. Therefore, in comparison with a direct-current motor constructed so that the direction of assembling the stator and the rotor and the direction of assembling the power supply brushes are different from each other, the assembling order of the respective parts is easily set, and the direct-current motor 1 is easily manufactured.

(6) Generally, a rotated body is directly joined to the output end of the rotary shaft 32. Therefore, as in the case of this embodiment, by disposing the stator including the power supply brushes 19 at the end opposite to the output end of the rotary shaft 32, the stator housing 11 can be removed from the rotor 3 without being obstructed by the rotated body. As a result, maintenance of the power supply brushes 19 is easily performed.

(7) Generally, in a direct-current motor, the positional relationship between the power supply brushes and the permanent magnets (field) is always constant. In this embodiment, by manufacturing the stator 2 at the stator assembling step, the positional relationship in the radial direction between the permanent magnets 16 and the power supply brushes 19 in the stator 2 is determined and kept constant. As a result, excellent accuracy of the direct-current motor 1 is maintained.

Hereinafter, a second embodiment of the present invention will be described with reference to the drawings. The same reference numerals are attached to the same members as in the first embodiment.

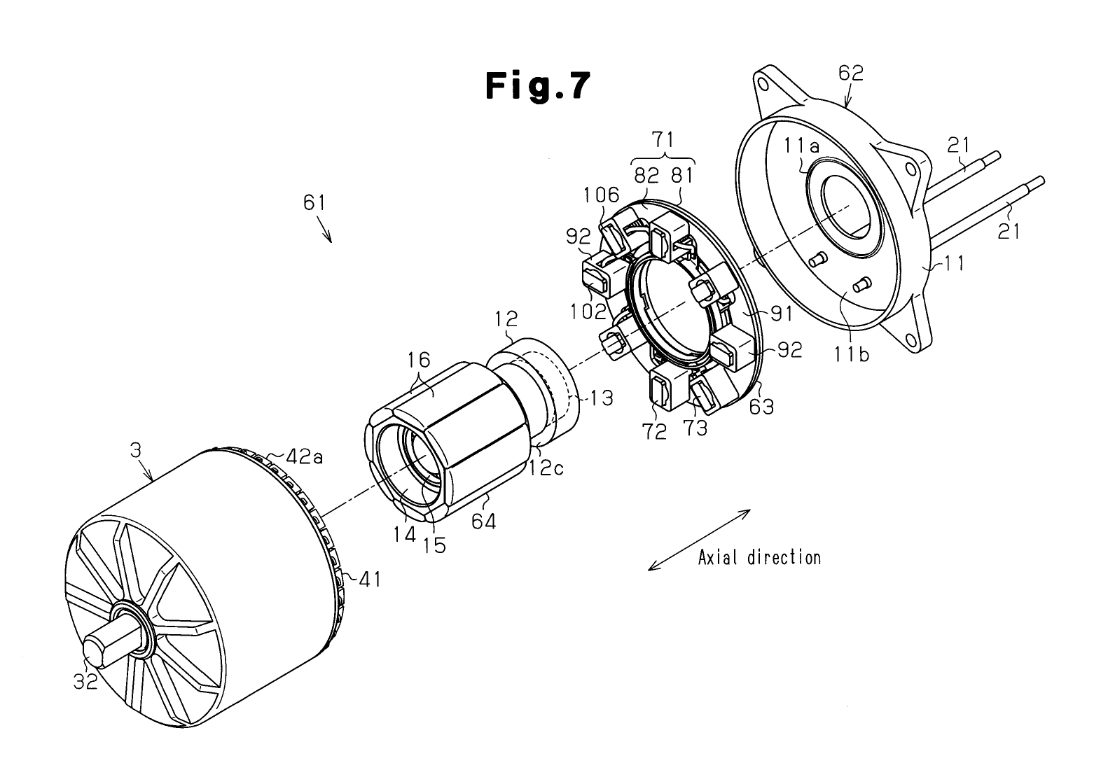

As shown in FIG. 7, a direct-current motor 61 of this embodiment includes a stator 62 and a rotor 3. The stator 62 includes a stator housing 11, a brush assembly 63 to be assembled in the axial direction of the rotary shaft 32 to the stator housing 11, and a field assembly 64 to also be assembled in the axial direction of the rotary shaft 32 to the stator housing 11.

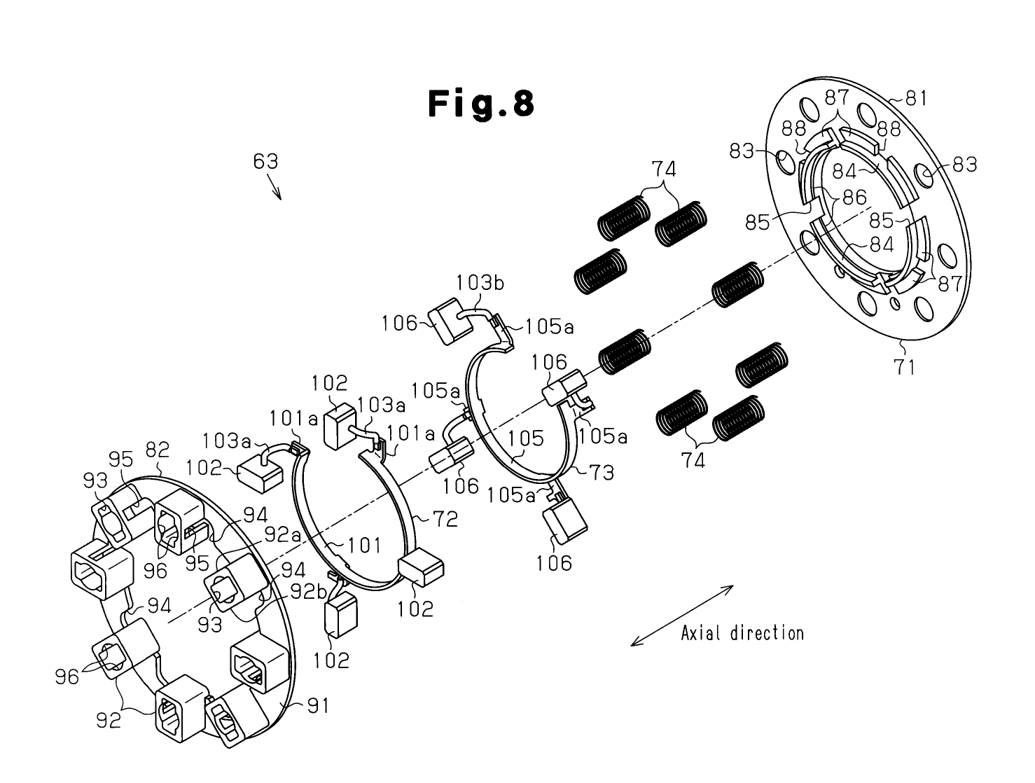

As shown in FIG. 7 and FIG. 8, the brush assembly 63 includes a ring-shaped brush holder 71, an anode brush assembly 72 to be housed in the brush holder 71, a cathode brush assembly 73, and eight coil springs 74.

The brush holder 71 includes a first divided holder 81 and a second divided holder 82 which are assembled in the axial direction of the rotary shaft 32 while overlapping each other. The first divided holder 81 is made of an insulating synthetic resin material, and is in a ring plate shape corresponding to the bottom surface 11b of the stator housing 11. The first divided holder 81 has an outer diameter substantially equal to the inner diameter of the side wall of the stator housing 11, and has an inner diameter substantially equal to the outer diameter of the protruding ridge 11a formed on the bottom surface of the stator housing 11. On a surface of the first divided holder 81 that corresponds to the second divided holder 82, first positioning recesses 83 for positioning the coil springs 74 are recessed at eight positions at equal angular intervals circumferentially. The first positioning recesses 83 are in a circular shape when viewed axially, and their diameters are substantially equal to the outer diameters of the coil springs 74.

On the inner peripheral edge of the first divided holder 81, four spacing walls 84 are provided along this inner peripheral edge. The spacing walls 84 are provided at equal angular intervals circumferentially, and between spacing walls 84 circumferentially adjacent to each other, a first recess 85 is formed by these spacing walls 84. On the proximal end of the spacing wall 84, an inner peripheral mounting portion 86 protruding radially inward is formed. The inner peripheral mounting portion 86 is formed along the circumferential direction from one end to the other end of the spacing wall 84. On the proximal end of each spacing wall 84, two outer peripheral mounting portions 87 protruding radially outward from the proximal end are formed. The outer peripheral mounting portions 87 are in arcuate shapes corresponding to the spacing wall 84, and are spaced from each other circumferentially to form a second recess 88 therebetween. The four first recesses 85 and the four second recesses 88 are positioned alternately circumferentially. The first recesses 85 and the second recesses 88 in this embodiment are provided at equal angular intervals (intervals of 45° in this embodiment) circumferentially.

A holder plate 91 constituting the second divided holder 82 is in a ring shape corresponding to the first divided holder 81, and its outer diameter is equal to that of the first divided holder 81, and its inner diameter is larger than that of the first divided holder 81. On the holder plate 91, eight brush holding parts 92 shaped into substantially rectangular tubes are formed integrally with the holder plate 91. The brush holding parts 92 extend to the opposite side of the first divided holder 81 along the axial direction from the holder plate 91, and are formed at equal angular intervals circumferentially on the holder plate 91. In the brush holding parts 92, holding holes 93 perforating axially through the holder plate 91 are formed. The shapes of the brush holding parts 92 from the axial direction are substantially rectangular. On the inner surfaces on both sides in the circumferential direction forming the holding hole 93 of each brush holding part 92, second positioning recesses 96 having arcuate shapes when viewed axially are formed. The second positioning recesses 96 are formed into arcuate shapes with a curvature substantially equal to the curvature of the outer diameter of the coil spring 74, and are formed along the axial direction across the brush holding part 92 and the holder plate 91.

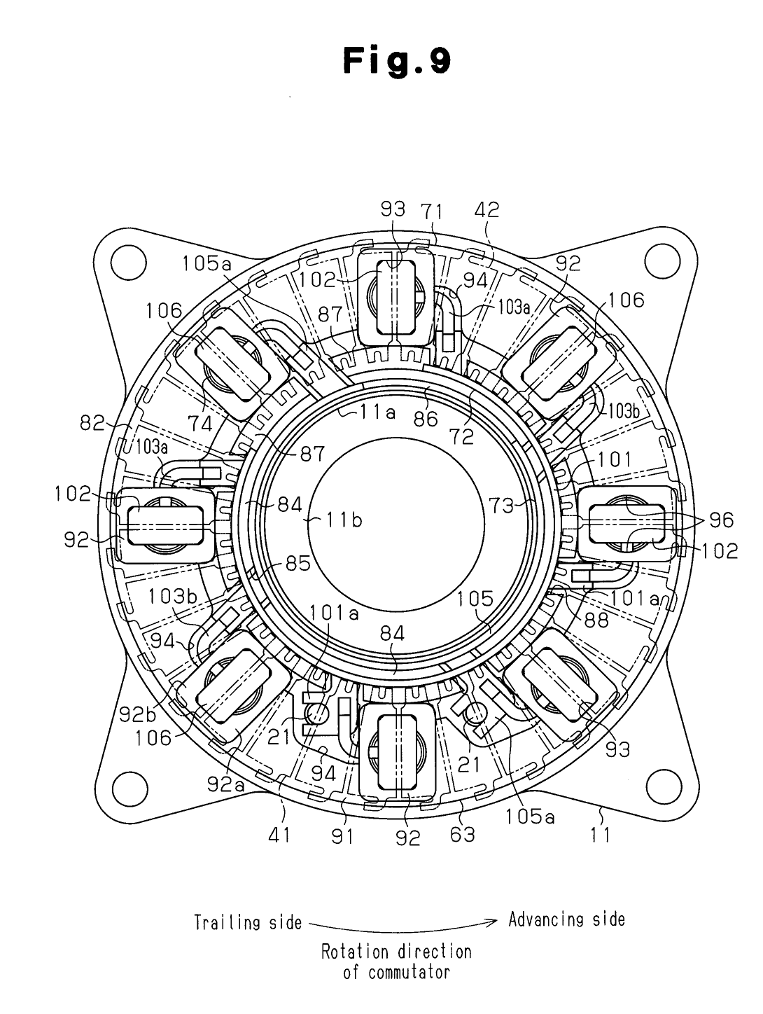

Of the two side walls 92a and 92b in the circumferential direction of each brush holding part 92, in the side wall 92b on the trailing side in the rotation direction of the commutator 41 (see FIG. 9) when the direct-current motor 61 is driven, an insertion groove 95 having an opening opened along the axial direction is formed at the end corresponding to the holder plate 91. The insertion groove 95 extends from the end of the side wall 92b that corresponds to the holder plate 91 to a point before the end of the same side wall 92b on the distal end of each brush holding part 92. In the holder plate 91, auxiliary grooves 94 extending radially inward from the openings of the insertion grooves 95 are formed. Among the eight auxiliary grooves 94, two auxiliary grooves 94, which are adjacent in the circumferential direction, are formed so as to be wider in circumferential width than the other auxiliary grooves 94.

The second divided holder 82 is assembled in the axial direction to the first divided holder 81 so that the holder plate 91 comes into contact with the side surface of the first divided holder 81 on which the first positioning recesses 83 are formed. In the state that the second divided holder 82 is assembled to the first divided holder 81, the brush holding parts 92 face the first positioning recesses 83. As shown in FIG. 9, on the inside of the second divided holder 82, the spacing walls 84, the inner peripheral mounting portions 86, and the outer peripheral mounting portions 87 are disposed, and the outer peripheral surfaces of the outer peripheral mounting portions 87 are in contact with the radially inside portions of the brush holding parts 92. The openings in the axial direction of the insertion grooves 95 are closed by the first divided holder 81.

As shown in FIG. 8, the anode brush assembly 72 includes one anode terminal 101, four anode power supply brushes 102, and four pigtails 103a which connect the respective anode power supply brushes 102 to the anode terminal 101. The anode terminal 101 is formed of a band-shaped conductive metal material, and is curved in an arcuate shape. The curvature of the inner peripheral surface of the anode terminal 101 is equal to the curvature of the outer peripheral surfaces of the spacing walls 84 of the first divided holder 81. The anode terminal 101 has integrally a total of four connecting pieces 101a on both ends and between both ends. The connecting pieces 101a are substantially rectangular, and extend toward the radially outside of the anode terminal 101. Onto each connecting piece 101a, one end of the pigtail 103a is connected, and the other end thereof is connected to the anode power supply brush 102 in a rectangular prism shape corresponding to the holding hole 93 of the brush holding part 92. The pigtail 103a is formed by covering a lead wire by an insulating outer coat.

Similarly, the cathode brush assembly 73 includes one cathode terminal 105, four cathode power supply brushes 106, and four pigtails 103b which connect the respective cathode power supply brushes 106 to the cathode terminal 105. The cathode terminal 105 is formed of a band-shaped conductive metal material, and is curved in an arcuate shape. The curvature of the outer peripheral surface of the cathode terminal 105 is equal to that of the inner peripheral surfaces of the spacing walls 84 of the first divided holder 81. The cathode terminal 105 has integrally a total of four connecting pieces 105a on both ends and between both ends. The connecting pieces 105a are substantially rectangular, and extend to the radially outside of the cathode terminal 105. Onto each connecting piece 105a, one end of the pigtail 103b is connected, and the other end thereof is connected to the cathode power supply brush 106 in a rectangular prism shape corresponding to the holding hole 93 of the brush holding part 92.

As shown in FIG. 9, the anode brush assembly 72 is assembled to the second divided holder 82 so that the anode power supply brushes 102 are inserted into the respective four brush holding parts 92 at 45° circumferentially among the eight brush holding parts 92 of the second divided holder 82, whereby the anode brush assembly 72 is held from both sides of the axial direction by the second divided holder 82 and the first divided holder 81. The cathode brush assembly 73 is assembled to the second divided holder 82 so that the cathode power supply brushes 106 are inserted into the brush holding parts 92 between the four brush holding parts 92 into which the anode power supply brushes 102 have been inserted, whereby the cathode brush assembly 73 is held from both sides of the axial direction by the second divided holder 82 and the first divided holder 81. In the state that the anode brush assembly 72 and the cathode brush assembly 73 are held by the second divided holder 82 and the first divided holder 81, the anode terminal 101 is disposed on the outer peripheral mounting portions 87 of the first divided holder 81 so as to come into contact with the outer peripheral surfaces of the spacing walls 84, and the cathode terminal 105 is disposed on the inner peripheral mounting portions 86 so as to come into contact with the inner peripheral surfaces of the spacing walls 84. The anode terminal 101 and the cathode terminal 105 are kept at a certain radial distance from each other by the spacing walls 84 so as to be prevented from being short-circuited by each other. The anode terminal 101 is electrically connected to one of two lead wires 21 for power supply, and the cathode terminal 105 is electrically connected to the other lead wire 21. The connecting pieces 101a of the anode terminal 101 are disposed in the second recesses 88, and disposed near the brush holding parts 92 for holding the anode power supply brushes 102. The connecting pieces 105a of the cathode terminal 105 are disposed between the first recesses 85 and near the brush holding parts 92 for holding the cathode power supply brushes 106.

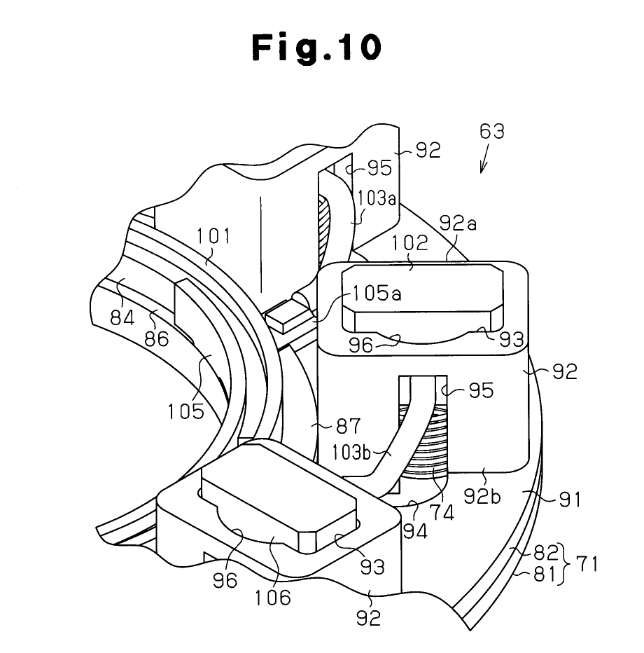

As shown in FIG. 9 and FIG. 10, the ends of the pigtails 103a and 103b corresponding to the power supply brushes 102 and 106 are connected to the side surfaces of the power supply brushes 102 and 106 on the trailing side in the rotation direction of the commutator 41. The pigtails 103a and 103b extend to the outsides of the brush holding parts 92 from the insertion grooves 95 of the brush holding parts 92 and are disposed on the further trailing side in the rotation direction of the commutator 41 than the power supply brushes 102 and 106. The respective pigtails 103a and 103b are movable axially within the insertion grooves 95 along with axial movement of the power supply brushes 102 and 106. The shapes of the pigtails 103a and 103b viewed from the axial direction of the rotary shaft 32 are curved shapes swelling to the trailing side in the rotation direction of the commutator 41. The shapes of the pigtails 103a and 103b viewed from the radial direction of the rotary shaft 32 are curved shapes swelling to the trailing side in the rotation direction of the commutator 41. Therefore, the respective power supply brushes 102 and 106 are urged to the advancing side in the rotation direction of the commutator 41 and pressed against the side walls 92a of the brush holding parts 92 on the advancing side in the rotation direction of the commutator 41 due to the force of restitution of the pigtails 103a and 103b. The force of restitution of the pigtails 103a and 103b is a force of restoring to the linear state from the curved state.

As shown in FIG. 10, inside the brush holding parts 92, coil springs 74 are disposed, respectively. The coil springs 74 are disposed in the second positioning recesses 96 inside the brush holding parts 92, and their ends correspond to the first divided holder 81 are disposed in the first positioning recesses 83, whereby the coil springs are positioned radially and circumferentially (see FIG. 8). The coil springs 74 urge the power supply brushes 102 and 106 toward the opening sides of the brush holding parts 92, that is, toward the sliding contact surface 42a of the commutator 41 (see FIG. 7).

As shown in FIG. 7, the field assembly 64 includes a support member 12, bearings 13 and 15 to be supported by the support member 12, a field core 14 fixed to the support member 12, and eight permanent magnets 16 fixed to the outer peripheral surface of the field core 14. The field assembly 64 is disposed on the inside of the protruding ridge 11a of the stator housing 11.

The stator 62 and the rotor 3 constructed as described above are assembled to each other by inserting the rotary shaft 32 of the rotor 3 into an insertion hole 12a of the support member 12 through an insertion recess 14b provided in the field core 14 of the stator 2 (see FIG. 2). In the state that the stator 62 and the rotor 3 are assembled to each other, the rotary shaft 32 is pivotally supported by the pair of bearings 13 and 15. On the outer periphery of the permanent magnets 16, an armature core 33 is disposed (see FIG. 2). The distal end faces of the anode power supply brushes 102 and the cathode power supply brushes 106 are in contact with the sliding contact surfaces 42a of the segments 42 constituting the commutator 41, and the portions of the outer peripheries (identical to the outer periphery of the direct-current motor 61) of the power supply brushes 102 and 106 are in contact with the sliding contact surfaces 42a at positions further radially outward of the armature coils 34 (see FIG. 2). The portion at the support 31c protruding to the inside of the rotor housing 31 is inserted into the inside of the insertion recess 14b formed in the field core 14 (see FIG. 2).

In the direct-current motor 61 constructed as described above, when a current is supplied to the armature coils 34 via the anode power supply brushes 102, the cathode power supply brushes 106, and the commutator 41, the rotor 3 rotates with respect to the stator 62 according to a rotating magnetic field generated by the rotor 3. When the rotor 3 rotates, the commutator 41 also rotates, and along with this, the segments 42 to be brought into sliding contact with the anode power supply brushes 102 and the cathode power supply brushes 106 change, and the armature coils 34 are successively commutated.

At this time, the pigtails 103a and 103b press the power supply brushes 102 and 106 toward the advancing side in the rotation direction of the commutator 41. When the commutator 41 rotates, due to frictional force between the sliding contact surfaces 42a of the segments 42 and the distal end faces of the power supply brushes 102 and 106, the power supply brushes 102 and 106 are pressed toward the advancing side in the rotation direction of the commutator 41. Therefore, the power supply brushes 102 and 106 are pressed against the side walls 92a of the brush holding parts 92 on the advancing side in the rotation direction of the commutator 41 by the pigtails 103a and 103b and the commutator 41, so that vibrations inside the brush holding parts 92 are suppressed.

Next, a manufacturing method for the direct-current motor 61 will be described. The direct-current motor 61 is manufactured through the brush assembly assembling step, a stator assembling step, a rotor assembling step, and a motor assembling step.

As shown in FIG. 8, at the brush assembly assembling step, the brush assembly 63 is manufactured by assembling the anode brush assembly 72, the cathode brush assembly 73, and the coil springs 74 to the brush holder 71. First, to the second divided holder 82, the anode brush assembly 72 and the cathode brush assembly 73 are assembled. The anode brush assembly 72 is assembled to the second divided holder 82 by inserting the four anode power supply brushes 102 into every other four brush holding parts 92 of the eight brush holding parts 92 of the second divided holder 82 along the axial direction from a side corresponding to the holder plate 91. At this time, the pigtails 103a which connect the anode power supply brushes 102 and the connecting pieces 101a to each other are disposed within the insertion grooves 95 through the auxiliary grooves 94 by the side of the brush holding parts 92 housing the respective anode power supply brushes 102. Similarly, the cathode brush assembly 73 is assembled to the second divided holder 82 by inserting four cathode power supply brushes 106 into the brush holding parts 92 between the brush holding parts 92 housing the anode power supply brushes 102 along the axial direction from a side corresponding to the holder plate 91. At this time, the pigtails 103b which connect the cathode power supply brushes 106 and the connecting pieces 101a are disposed within the insertion grooves 95 through the auxiliary grooves 94 by the side of the brush holding parts 92 housing the respective cathode power supply brushes 106. Into the brush holding parts 92 in which the power supply brushes 102 and 106 have been housed, the coil springs 74 are inserted along the axial direction of the rotary shaft 32 from a side corresponding to the holder plate 91 (inserting step). At this time, since the insertion grooves 95 are not opened to the distal end of the brush holding parts 92, the pigtails 103a and 103b are disposed within the insertion grooves 95. Therefore, the power supply brushes 102 and 106 are prevented from falling off the openings of the brush holding parts 92. The anode terminal 101 and the cathode terminal 105 are disposed on the inside of the second divided holder 82. Inside the anode terminal 101, the cathode terminal 105 is disposed.

Next, the first divided holder 81 and the second divided holder 82 are moved relatively so as to come close to each other along the axial direction and assembled (holder assembling step). The first divided holder 81 and the second divided holder 82 are moved relatively until the first divided holder 81 and the holder plate 91 come into contact with each other in a state that the side surface of the first divided holder 81 on which the first positioning recesses 83 are formed and the side surface of the holder plate 91 opposite to the brush holding parts 92 are made to face each other. At this time, the ends on a side corresponding to the first divided holder 81 of the coil springs 74 inserted into the respective brush holding parts 92 are housed inside the first positioning recesses 83. The first divided holder 81 and the holder plate 91 are brought into contact with each other so that the anode terminal 101 is disposed on the outer peripheral mounting portions 87 of the spacing walls 84 and the cathode terminal 105 is disposed on the inner peripheral mounting portions 86. That is, between the anode terminal 101 and the cathode terminal 105, spacing walls 84 are disposed. When the first divided holder 81 and the holder plate 91 are brought into contact with each other, the first divided holder 81 closes the openings in the axial direction of the insertion grooves 95.

At the stator assembling step, as shown in FIG. 7, the stator 62 is manufactured by assembling the field assembly 64 and the brush assembly 63 to the stator housing 11. First, the stator housing 11 and the brush assembly 63 are moved relatively along the axial direction so as to come close to each other in a state that the opening of the stator housing 11 and the first divided holder 81 of the brush assembly 63 face each other. The stator housing 11 and the brush assembly 63 are moved relatively until the first divided holder 81 comes into contact with the bottom surface of the stator housing 11. The brush assembly 63 is disposed on the outer periphery of the protruding ridge 11a on the bottom surface 11b of the stator housing 11. Then, the field assembly 64 is assembled to the stator housing 11. The field assembly 64 is moved relatively along the axial direction with respect to the stator housing 11 in a state that the end on a side corresponding to the bearing 13 and the portion inside the protruding ridge 11a on the bottom surface of the stator housing 11 face each other. The end of the field assembly 64 on a side corresponding to the bearing 13 is disposed inside the protruding ridge 11a of the stator housing 11.

By manufacturing the stator 62 through the stator assembling step, the positional relationship in the radial direction between the permanent magnets 16 and the anode power supply brushes 102 and the cathode power supply brushes 106 is determined. In the manufactured stator 62, this positional relationship is kept constant.

The rotor assembling step of this embodiment is similar to that of the first embodiment. The stator assembling step and the rotor assembling step may be performed concurrently, or either one assembling step may be performed first. The brush assembling step and the rotor assembling step may be performed concurrently, or either one step may be performed first.

Thereafter, at the motor assembling step, the stator 62 and the rotor 3 are assembled to each other. At the motor assembling step, the stator 62 and the rotor 3 are moved relatively along the axial direction of the rotary shaft 32 in a state that the opening of the stator housing 11 and the opening 31e of the rotor housing 31 face each other (see FIG. 2). Thereby, the end of the rotary shaft 32 on a side corresponding to the opening 31e of the rotor housing 31 is inserted into the insertion hole 12a from the insertion recess 14b of the support member 12 of the stator 2, and the rotary shaft 32 is pivotally supported by the bearings 13 and 15. At the same time, the permanent magnets 16 are inserted into the armature core 33 through the inside of the commutator 41, and the portion of the support 31c protruding to the inside of the rotor housing 31 is inserted into the inside of the insertion recess 14b. Then, when the stator 62 and the rotor 3 are relatively moved along the axial direction until the rotary shaft 32 is pivotally supported by the bearings 13 and 15. At the same time, the distal end faces of the anode power supply brushes 102 and the cathode power supply brushes 106 come into contact with the sliding contact surfaces 42a of the segments 42 constituting the commutator 41.

As described above, the second embodiment has the following advantages in addition to the advantages similar to (1), (2), (4), (5), (6), and (7) of the first embodiment.

(8) The brush assembly 63 and the field assembly 64 are both assembled to the stator housing in the axial direction of the rotary shaft 32. Therefore, the assembling directions of the brush assembly 63 and the field assembly 64 to the stator housing 11 are unified in the axial direction, so that the stator 62 is easily manufactured.

(9) The first divided holder 81 and the second divided holder 82 are assembled to each other in the axial direction of the rotary shaft 32 to form a brush holder 71, and the power supply brushes 102 and 106 and the coil springs 74 are inserted into the second divided holder 82 from the axial direction. Thus, when the assembling directions of the brush holder 71, the power supply brushes 102 and 106, and the coil springs 74 constituting the brush assembly 63 are unified in the axial direction, the brush assembly 63 is easily manufactured. As a result, the stator 62 is more easily manufactured.

(10) The anode power supply brushes 102 and the anode terminal 101 are connected via pigtails 103a and 103b to form an assembly. Also, the cathode power supply brushes 106 and the cathode terminal 105 are connected via the pigtails 103a and 103b to form an assembly. Therefore, the brush holder 71 and the power supply brushes 102 and 106 are easily assembled to each other.

(11) The openings of the insertion grooves 95 formed in the brush holding parts 92 of the second divided holder 82 are closed by the first divided holder 81. Therefore, the pigtails 103a and 103b are prevented from being disengaged axially from the insertion grooves 95, so that the power supply brushes 102 and 106 to which the pigtails 103a and 103b are connected are prevented from being disengaged from the brush holding parts 92.

(12) The ends of the pigtails 103a and 103b on a side corresponding to the power supply brushes 102 and 106 are connected to the side surfaces of the power supply brushes 102 and 106 on the trailing side in the rotation direction of the commutator 41, and the pigtails are disposed on the further trailing side in the rotation direction of the commutator 41 than the connected power supply brushes 102 and 106. Therefore, the power supply brushes 102 and 106 are pressed to the advancing side in the rotation direction of the commutator 41 by the pigtails 103a and 103b. When the commutator 41 rotates, the power supply brushes 102 and 106 are pressed to the advancing side in the rotation direction of the commutator 41 by the frictional force between the distal end faces of the power supply brushes 102 and 106 and the sliding contact surfaces 42a. Therefore, when the power supply brushes 102 and 106 are pressed by the pigtails 103a and 103b, the pressing direction of the power supply brushes 102 and 106 by the pigtails 103a and 103b and the direction of the frictional force between the distal end faces of the power supply brushes 102 and 106 and the sliding contact surfaces 42a when the commutator 41 rotates become the same direction, so that the power supply brushes 102 and 106 are pressed against the side walls 102a of the brush holding parts 92 on the advancing side in the rotation direction of the commutator 41. As a result, the positions of the power supply brushes 102 and 106 inside the brush holding parts 92 become stable and the vibrations of the power supply brushes 102 and 106 are suppressed.

(13) The pigtails 103a and 103b are in curved shapes when viewed from the axial direction, and are in curved shapes when viewed from the radial direction. Therefore, by the force of restitution of the pigtails 103a and 103b, the power supply brushes 102 and 106 are effectively pressed to the advancing side in the rotation direction of the commutator 41. As a result, vibrations of the power supply brushes 102 and 106 are further suppressed. By forming the pigtails 103a and 103b in curved shapes, the pigtails 103a and 103b are provided with appropriate rigidity.

Next, a third embodiment of the present invention will be described with reference to the drawings. The same members as in the first embodiment and the second embodiment are attached with the same reference numerals.

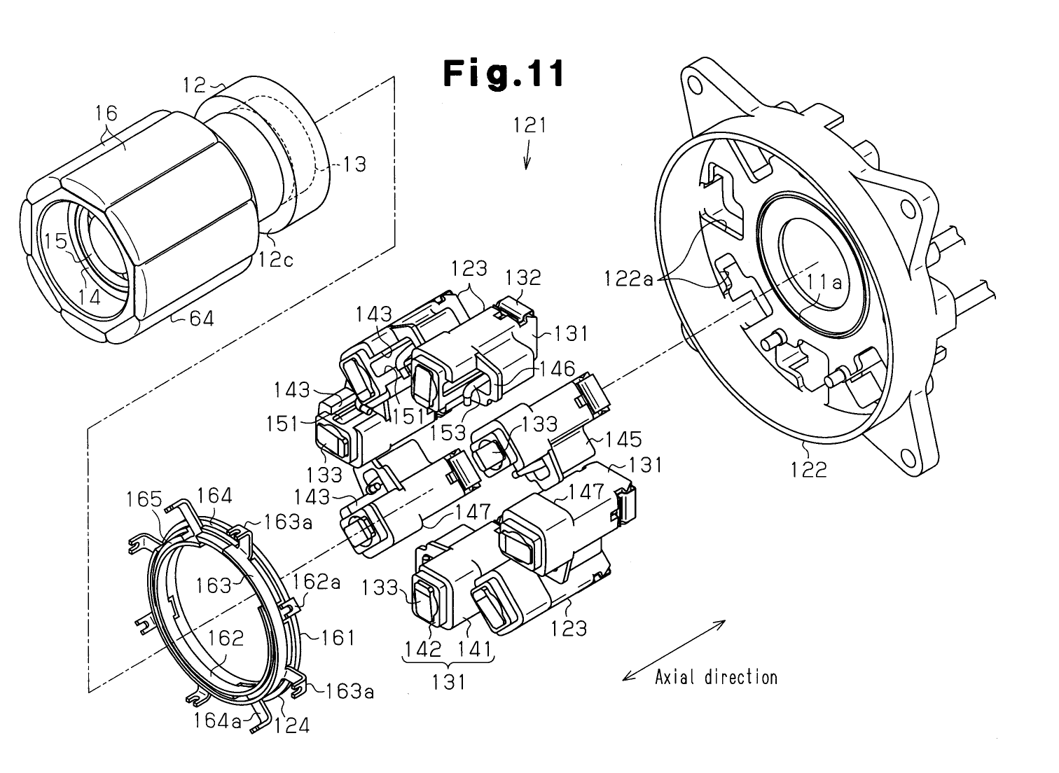

A stator 121 of this embodiment is provided in the direct-current motor 1. As shown in FIG. 11, the stator 121 includes a stator housing 122, eight brush assemblies 123 to be assembled to the stator housing 122 in the axial direction of the rotary shaft 32, a terminal assembly 124, and a field assembly 64.

The stator housing 122 corresponds to the stator housing 11 of the first embodiment provided with eight attaching holes 122a formed in the bottom thereof. The eight attaching holes 122a are formed at equal angular intervals circumferentially in the bottom of the stator housing 122, and shaped corresponding to the outside shapes of the brush assemblies 123.

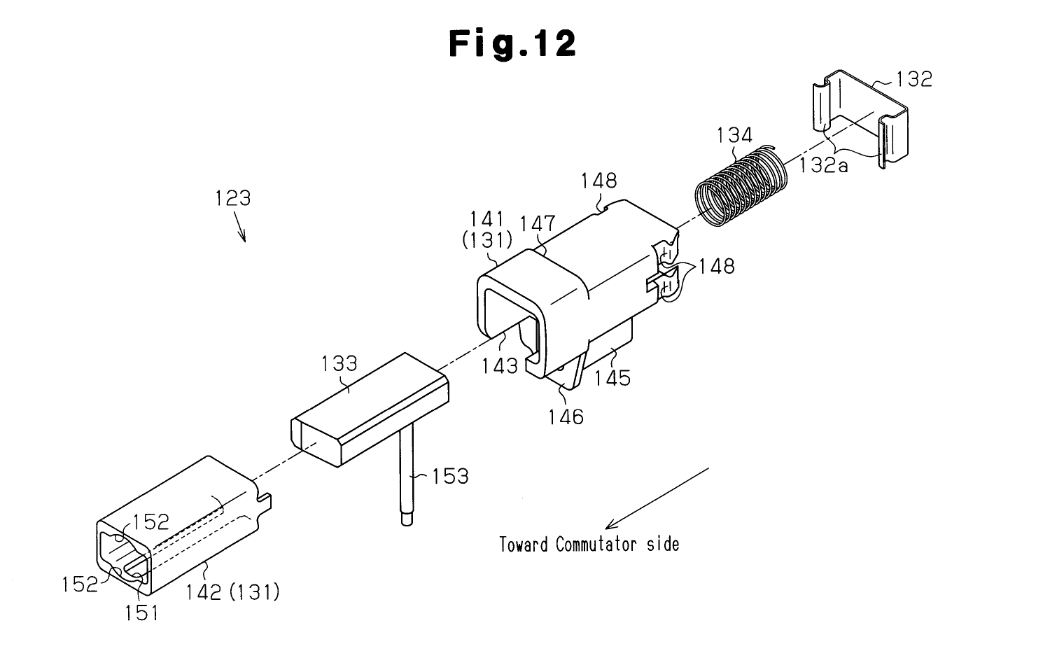

As shown in FIG. 12, the brush assembly 123 includes a brush holder 131, a cap 132 to be attached to the brush holder 131, a power supply brush 133 to be held by the brush holder 131, and a coil spring 134.

The brush holder 131 includes a first divided holder 141 in a substantially rectangular tube shape, and a second divided holder 142 in a substantially rectangular tube shape to be disposed inside of the first divided holder 141. The first divided holder 141 made of a synthetic resin material is formed into a substantially rectangular tube shape extending along the axial direction. In the lower side wall in FIG. 12 among four side walls constituting the first divided holder 141, a first insertion groove 143 having an opening in the axial direction at a side corresponding to the end on the commutator 41 (left side in FIG. 12) of the side wall is formed. The first insertion groove 143 extends from one end of the first divided holder 141 at a side corresponding to the commutator 41 to a point before the other end opposite to the commutator 41 along the axial direction. On the outside surface of the first divided holder 141, a pigtail housing 145 is integrally formed so as to cover the end of the first insertion groove 143 opposite to the opening, and at the opening of the pigtail housing 145, a flange-shaped stopper 146 extending in a direction orthogonal to the extending direction of the first divided holder 141 (that is, the axial direction of the rotary shaft 32) is provided. As shown in FIG. 14, on the side wall of the first divided holder 141 opposite to the side wall with the insertion groove 143, a step 147 is formed by making a portion of this side wall on a side corresponding to the commutator 41 thick toward the outside. This step 147 is formed such that its position in the longitudinal direction of the first divided holder 141 becomes the same position as the stopper 146.

As shown in FIG. 12, on the two side walls among the four side walls of the first divided holder 141, or on side walls other than the side wall having the first insertion groove 143 and the side wall having the step 147, engagement recesses 148 are formed at the ends opposite to the commutator 41. The cap 132 is formed so as to have a channel-like cross-sectional shape, and on both ends thereof, engagement projections 132a protruding inward are formed. By engagement of the engagement projections 132a with the engagement recesses 148, the cap 132 and the first divided holder 141 are latched in the axial direction, whereby, as shown in FIG. 11, one end of the first divided holder 141 is substantially closed.

The second divided holder 142 made of an insulating synthetic resin material is formed into a rectangular tube shape corresponding to the inner peripheral surface of the first divided holder 141, and is inserted into the first divided holder 141 along the axial direction (see FIG. 11). At a position corresponding to the first insertion groove 143 of the first divided holder 141 in the second divided holder 142, a second insertion groove 151 extending from one end of the second divided holder 142 opposite to the commutator 41 to a point before the other end that corresponds to the commutator 41 is formed. The second insertion groove 151 has an opening opened axially at the end of the second divided holder 142 opposite to the commutator 41. The width of the opening is narrower than the width of the first insertion groove 143. In a state that the second divided holder 142 is inserted inside the first divided holder 141, the side wall having the first insertion groove 143 of the first divided holder 141 faces the opening of the second insertion groove 151 in the thickness direction of this side wall, and the opening of the second insertion groove 151 is closed by the first divided holder 141. The side wall having the second insertion groove 151 of the second divided holder 142 faces the opening of the first insertion groove 143 in the thickness direction of this side wall, and the aperture to the inside of the opening of the first insertion groove 143 is closed by the second divided holder 142.

On the inner surface of the side wall having the second insertion groove 151 of the second divided holder 142 and the inner surface of the side wall opposite to the side wall, positioning recesses 152 are formed so as to have an arcuate cross-sectional shape. The curvature of the positioning recesses 152 is substantially equal to the curvature of the outer diameter of the compression coil spring 134. Both positioning recesses 152 extend from one end to the other end in the longitudinal direction of the second divided holder 142 along the axial direction of the second divided holder 142.

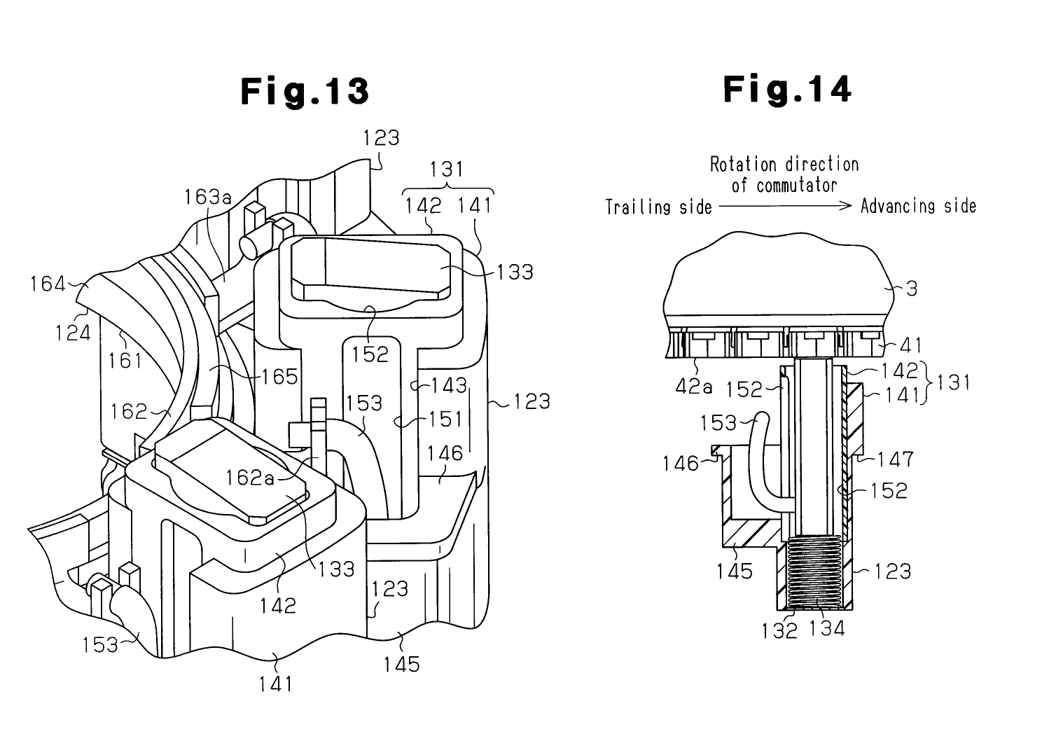

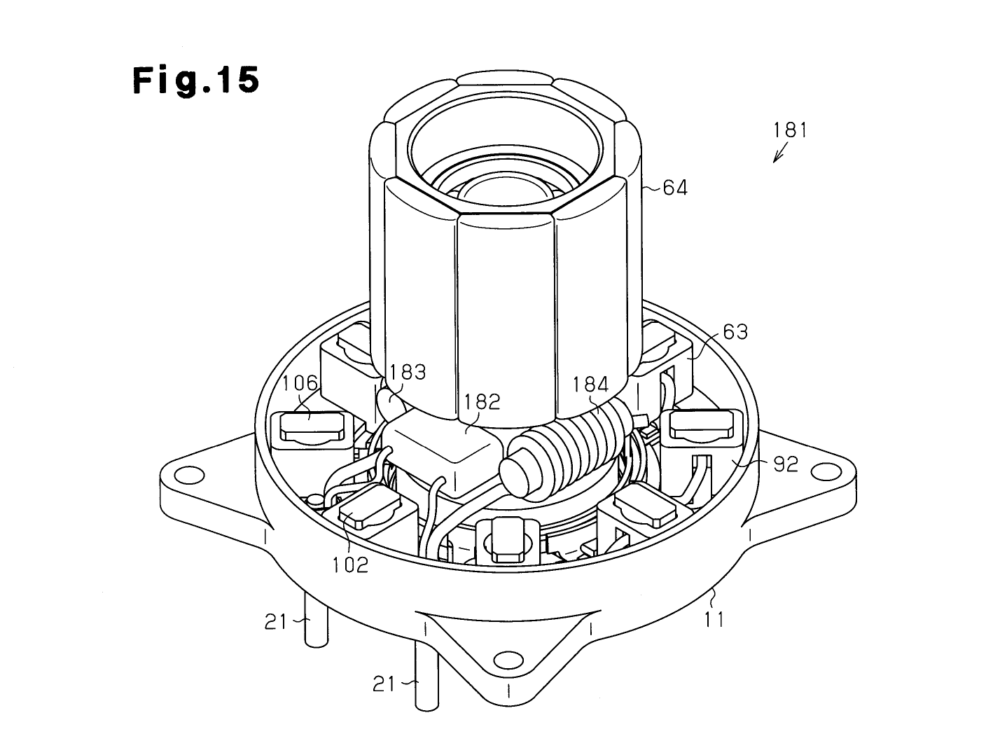

Inside the second divided holder 142, a power supply brush 133 shaped into a rectangular prism corresponding to the inner peripheral surface of the second divided holder 142 is inserted. On the outer peripheral surface of the power supply brush 133, one end of the pigtail 153 obtained by covering a lead wire by an insulating outer coat is connected to a portion corresponding to the second insertion groove 151. As shown in FIG. 13 and FIG. 14, a part of the pigtail 153 is substantially housed inside the pigtail housing 145, and extends to the outside of the second divided holder 142 through the second insertion groove 151 and the first insertion groove 143. Each pigtail 153 is movable in the axial direction inside the second insertion groove 151 along with axial movement of the first divided holder 141 of the power supply brush 133.

As shown in FIG. 14, the coil spring 134 is disposed between the power supply brush 133 and the cap 132, and the power supply brush 133 is urged toward the commutator 41 by this compression coil spring 134. The end of the coil spring 134 on a side corresponding to the power supply brush 133 is disposed within the positioning recess 152 formed in the second divided holder 142.

As shown in FIG. 11, in the brush assembly 123, the end on a side corresponding to the cap 132 is inserted into the attaching hole 122a from the bottom surface of the stator housing 122, whereby the brush assembly 123 is assembled to the stator housing 122. In the state that the brush assembly 123 is assembled to the stator housing 122, the first insertion groove 143 and the second insertion groove 151 are disposed on the trailing side in the rotation direction of the commutator 41 when the direct-current motor is driven. According to contact of the stopper 146 and the step 147 with the peripheral edge of the attaching hole 122a in the bottom surface of the stator housing 122, the brush assembly 123 is prevented from falling off to the outside of the stator housing 122.

The terminal assembly 124 includes a ring-shaped holding member 161 to be disposed between the outer periphery of a protruding ridge 11a formed on the bottom surface of the stator housing 122 and the inner peripheries of the eight brush assemblies 123, and two terminals 162 and 163.

The holding member 161 has a ring-shaped mounting portion 164 and four spacing walls 165 stood axially from the radially central portion of the mounting portion 164. The spacing walls 165 are formed at equal angular intervals in the circumferential direction, and formed into curved shapes along the circumferential direction of the holding member 161. The anode terminal 101 is formed of a conductive band-shaped metal material, and is curved in an arcuate shape.

The terminal 162 is formed of a conductive band-shaped metal material, and is curved in an arcuate shape. The terminal 162 has integrally a total of four connecting pieces 162a on both ends and between both ends. The connecting pieces 162a extend to the radially outside of the terminal 162. The terminal 162 is disposed on the mounting portion 164 inside of the four spacing walls 165, and the connecting pieces 162a are disposed between the spacing walls 165. The terminal 163 is also formed of a conductive band-shaped metal material, and curved in an arcuate shape. The terminal 163 has integrally a total of four connecting pieces 163a on both ends and between both ends. The connecting pieces 163a extend toward the radially outside of the terminal 163. The terminal 163 is disposed on the mounting portion 164 outside the four spacing walls 165, and the connecting pieces 163a are disposed between the connecting pieces 162a of the terminal 162. When viewing the terminal assembly 124 from the axial direction, the connecting pieces 162a and the connecting pieces 163a are disposed alternately circumferentially. The connecting pieces 162a and the connecting pieces 163a of this embodiment are disposed at equal angular intervals (45° in this embodiment) circumferentially.

The terminal assembly 124 thus constructed is disposed radially inside the brush assembly 123 so that the outer peripheral edge of the mounting portion 164 comes into contact with the eight brush assemblies 123. As shown in FIG. 13, the connecting piece 162a and the connecting piece 163a are disposed near the opening of the pigtail housing 145 of the brush assembly 123, and are electrically connected to the other end of the pigtail 153. One lead wire 21 of the two lead wires 21 (see FIG. 11) is electrically connected to the terminal 162, and the other lead wire 21 is electrically connected to the terminal 163.

Next, the pigtail 153 will be described in detail. As shown in FIG. 14, in the state that the brush assemblies 123 are assembled to the stator housing 122 (see FIG. 11), the first insertion grooves 143 and the second insertion grooves 151 are disposed on the trailing side in the rotation direction of the commutator 41 when the direct-current motor is driven. One end of each pigtail 153 is connected to the side surface of the corresponding power supply brush 133 on the trailing side in the rotation direction of the commutator 41, and each pigtail 153 is disposed on the trailing side in the rotation direction of the commutator 41 in each connected power supply brush 133. Each pigtail 153 is in a curved shape swelling to the trailing side in the rotation direction of the commutator 41 when viewed from the radial direction (radial direction of the rotary shaft 32). Therefore, each power supply brush 133 is urged to the advancing side in the rotation direction of the commutator 41 by the force of restitution of the pigtail 153. Therefore, each power supply brush 133 is pressed against the side wall of the second divided holder 142 on the advancing side in the rotation direction of the commutator 41. The force of restitution of the pigtail 153 is a force of restoring from the curved state into a linear state.

As shown in FIG. 11 and FIG. 2, the stator 121 and the rotor 3 constructed as described above are assembled to each other by inserting the rotary shaft 32 of the rotor 3 into the insertion hole 12a of the support member 12 through the insertion recess 14b provided in the field core 14 of the stator 2. In the state that the stator 121 and the rotor 3 are assembled to each other, the rotary shaft 32 is pivotally supported by the pair of bearings 13 and 15, and an armature core 33 is disposed on the outer periphery of the permanent magnets 16. With the sliding contact surfaces 42a of the segments 42 constituting the commutator 41, the front end faces of the power supply brushes 133 come into contact, and the portions on the outer peripheries of the power supply brushes 133 come into contact with the sliding contact surfaces at the further radially outward than the armature coils 34 (see FIG. 2). The portion of the support 31c protruding to the inside of the rotor housing 31 is inserted into the insertion recess 14b formed in the field core 14.

Next, a manufacturing method for the stator 121 constructed as described above will be described. The stator 121 is manufactured through a brush assembly assembling step, a terminal assembly assembling step, and a stator assembling step.

As shown in FIG. 12, at the brush assembly assembling step, first, the power supply brush 133 is inserted into the second divided holder 142 along the axial direction of the divided holder 142. At this time, the power supply brush 133 is inserted into the second divided holder 142 while the end of the pigtail 153 on a side corresponding to the power supply brush 133 is inserted into the second insertion groove 151 along the axial direction. Then, the second divided holder 142 is inserted into the first divided holder 141 together with the power supply brush 133 (holder assembling step). At this time, the end of the pigtail 153 on a side corresponding to the power supply brush is inserted into the first insertion groove 143 along the axial opening of the first divided holder 141. Thereby, the pigtail 153 is substantially housed inside the pigtail housing 145.

Next, from the opening of the first divided holder 141 on a side corresponding to the engagement recess 148, the coil spring 134 is inserted into the first divided holder 141 along the axial direction (inserting step). At this time, the end of the coil spring 134 on a side corresponding to the power supply brush 133 is disposed within the positioning recess 152 of the second divided holder 142. By engaging the engagement projection 132a of the cap 132 with the engagement recess 148 of the first divided holder 141 in the axial direction, the cap 132 is assembled to the first divided holder 141.

At the terminal assembly assembling step, the terminal 162 is disposed on the mounting portion 164 inside the four spacing walls 165, and the terminal 163 is disposed on the mounting portion 164 outside the four spacing walls 165. At this time, the connecting pieces 162a are disposed between the spacing walls 165, and the connecting pieces 163a are disposed between the connecting pieces 162a. The brush assembly assembling step and the terminal assembly assembling step may be concurrently performed, or the terminal assembly assembling step may be performed first.

As shown in FIG. 11, at the stator assembling step, the brush assemblies 123, the terminal assembly 124, and the field assembly 64 are assembled to the stator housing 122. First, by inserting the eight brush assemblies 123 into the attaching holes 122a of the stator housing 122 in the axial direction, the brush assemblies 123 are assembled to the stator housing 122. At this time, the brush assemblies 123 are inserted into the attaching holes 122a from the ends corresponding to the cap 132 so that the first insertion grooves 143 and the second insertion grooves 151 come to the trailing side in the rotation direction of the commutator 41. Then, to the stator housing 122 to which the brush assemblies 123 have been assembled, the terminal assembly 124 is assembled. The terminal assembly 124 is relatively moved along the axial direction so as to come closer to the terminal assembly 124 in a state that the surface of the mounting portion 164 opposite to the spacing walls 165 are made to face the bottom surface of the stator housing 122.

As shown in FIG. 13, the terminal assembly 124 is disposed inside the eight brush assemblies 124, and the connecting pieces 162a and the connecting pieces 163a are disposed near the openings of the pigtail housings 145 of the respective brush holders 131. The pigtails 153 are electrically connected to the corresponding connecting pieces 162a and 163a, respectively. Then, the field assembly 64 is assembled to the stator housing 122. The field assembly 64 is relatively moved with respect to the stator housing 122 along the axial direction in a state that its end corresponding to the bearing 13 and the portion on the bottom surface of the stator housing 122 inside the protruding ridge 11a face each other. The end of the field assembly 64 corresponding to the bearing 13 is disposed inside the protruding ridge 11a of the stator housing 122.

By manufacturing the stator 121 through this stator assembling step, the positional relationship in the radial direction between the permanent magnets 16 and the power supply brushes 133 is determined. In the manufactured stator 121, this positional relationship is kept constant. Thereafter, as in the case of the second embodiment, the rotor and the stator 121 are assembled to each other.

As described above, this third embodiment has the following advantages in addition to the advantages (1), (2), (4), (5), (6), and (7) of the first embodiment and the advantages (8) and (12) of the second embodiment.

(14) Since the assembling directions of the brush holder 131, the cap 132, the power supply brush 133, and the coil spring 134 constituting the brush assembly 123 are unified in the same axial direction, the brush assembly 123 is easily manufactured. Therefore, the stator 121 is more easily manufactured.

(15) Since each brush assembly 123 includes one each of the brush holders 131, the caps 132, the power supply brushes 133, and the coil springs 134, each brush assembly 123 is easily manufactured. Since the terminal assembly 124 is assembled to the stator housing 122 in the axial direction similar to the field assembly 64 and the brush assembly 123 constituting the stator 121, the stator with the terminal assembly 124 is easily manufactured.

(16) The opening along the axial direction of the first insertion groove 143 formed in the first divided holder 141 is closed by the second divided holder 142. The opening along the axial direction of the second insertion groove 151 formed in the second divided holder 142 is closed by the first divided holder 141. Therefore, the pigtail 153 is prevented from being disengaged from in the axial direction from the insertion grooves 143 and 151, so that the power supply brush 133 to which the pigtail 153 is connected is prevented from being disengaged from of the brush holder 131.

When the power supply brush 133 is worn out, the pigtail 153 comes into contact with the second divided holder 142 and is suppressed from moving toward the sliding contact surface 42a. Therefore, by the simple construction, short-circuiting between the pigtail 153 and the segment 42 is prevented.

(17) The pigtail 153 presses the corresponding power supply brush 133 to the advancing side in the rotation direction of the commutator 41. When the commutator 41 rotates, due to the frictional force between the sliding contact surface 42a of the segment 42 and the distal end face of the power supply brush 133, the power supply brush 133 is pressed to the advancing side in the rotation direction of the commutator 41. Therefore, the power supply brush 133 is pressed against the side wall of the brush holder 131 on the advancing side in the rotation direction of the commutator 41 by the pigtail 153 and the commutator 41, so that vibration of the power supply brush inside the brush holder 131 is suppressed. The pigtail 153 is curved when viewed from the axial direction. Therefore, by the force of restitution of the pigtail 153, the power supply brush 133 is effectively pressed to the advancing side in the rotation direction of the commutator 41. As a result, the vibration of the power supply brush 133 is further suppressed.

Next, a fourth embodiment of the present invention will be described with reference to the drawings. The same components as in the first through third embodiments are attached with the same reference numerals.

The stator 181 of this embodiment is obtained by providing the stator 62 of the second embodiment with one capacitor 182 and two choke coils 183 and 184 as a noise reduction member.

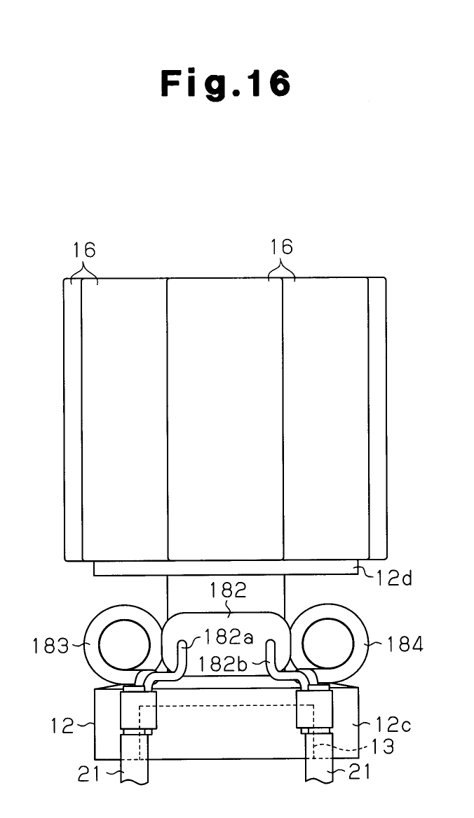

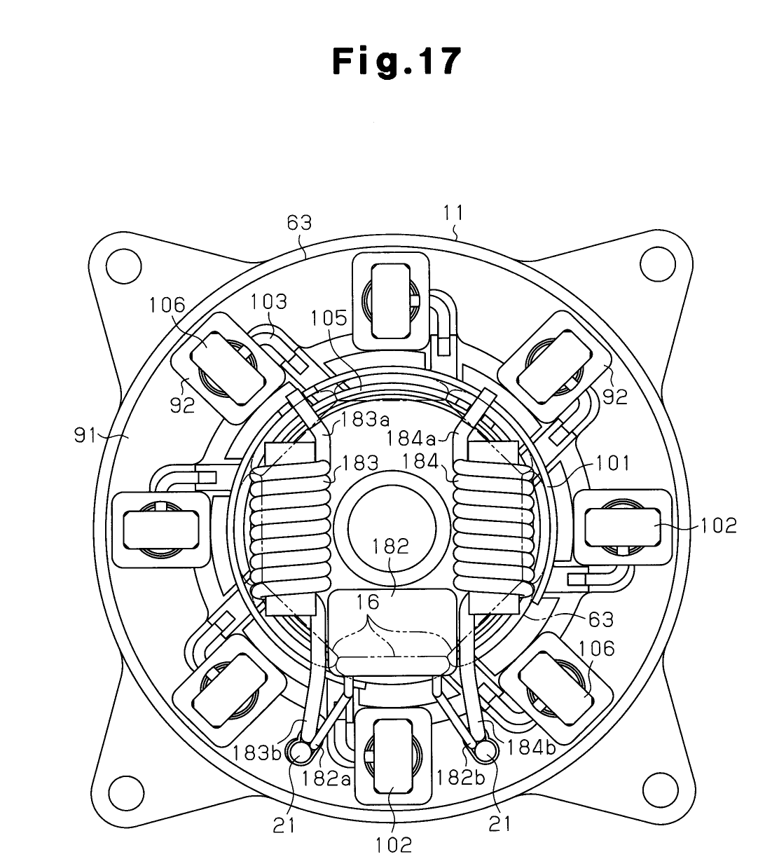

As shown in FIG. 16, in the field assembly 64, the permanent magnets 16 and the bearing 13 are spaced from each other along the axial direction of the permanent magnets 16. The capacitor 182 and the choke coils 183 and 184 are disposed between the permanent magnets 16 and the bearing 13 in the stator 181, that is, the outer periphery of a portion of the support member 12 between the bearing holder 12c and the flange 12d. Two choke coils 183 and 184 are disposed on both sides in the circumferential direction of the capacitor 182. When observing the stator 181 from the axial direction, as shown in FIG. 17, the capacitor 182 and the choke coils 183 and 184 are disposed on the further radially inward than the outer peripheral surfaces of the eight permanent magnets 16.

Two terminals 182a and 182b of the capacitor 182 are connected to two lead wires 21. One terminal 183a of the choke coil 183 is connected to the anode terminal 101, and the other terminal 183b is connected to one lead wire 21. One terminal 184a of the choke coil 184 is connected to the cathode terminal 105, and the other terminal 184b is connected to the other lead wire 21.

These capacitor 182 and choke coils 183 and 184 prevent generation of electromagnetic noise according to the rotation of the direct-current motor when the direct-current motor with the stator 181 is driven.

As described above, this fourth embodiment has the following advantages in addition to the advantages (1), (2), (4), (5), (6), and (7) of the first embodiment and the advantages (8) through (13) of the second embodiment.

(18) Generation of electromagnetic noise according to the rotation of the direct-current motor is prevented by the capacitor 182 and the choke coils 183 and 184, so that the rotation of the direct-current motor with the stator 181 becomes stable.

(19) The permanent magnets 16 are disposed on the outer periphery of the support member 12 via the field core 14, and protrude further radially outward than the outer peripheral surface of the support member 12. The permanent magnets 16 and the bearing 13 are positioned so as to be spaced in the axial direction. Therefore, a space is created between the bearing 13 disposed on the end of the support member 12 that corresponds to the stator housing 11 and the permanent magnets 16. That is, a space is created at the outer periphery of the section between the permanent magnets 16 and the bearing 13 in the support member 12. By disposing the capacitor 182 and the choke coils 183 and 184 in this space, the increase in size of the stator 181 due to the provision of the capacitor 182 and the choke coils 183 and 184 is prevented.

(20) The capacitor 182 and the choke coils 183 and 184 are disposed on the further radially inward than the outer peripheral surface of the eight permanent magnets 16. Therefore, an increase in size of the stator due to the provision of the capacitor 182 and the choke coils 183 and 184 is further suppressed. When assembling the rotor 3 and the stator 181 in the axial direction, the capacitor 182 and the choke coils 183 and 184 are prevented from coming into contact with the rotor 3 and obstructing the assembly.

The respective embodiments described above may be changed as follows.

In the fourth embodiment, the capacitor 182 and the choke coils 183 and 184 are disposed on the further radially inward than the outer peripheral surface of the eight permanent magnets 16. However, a part or whole of the capacitor 182 and the choke coil 183 and 184 may be disposed on the further radially outward than the permanent magnets 16. By disposing the capacitor 182 and the choke coils 183 and 184 on the outer periphery between the permanent magnets 16 and the bearing 13 in the support member 12, the same advantage as (19) of the fourth embodiment is obtained.

In the fourth embodiment, the stator 181 includes one capacitor 182 and two choke coils 183 and 184 which function as a noise reduction member. However, the circuit elements of the noise reduction member are not limited to these. For example, the noise reduction member may include only one choke coil, or may include one each of choke coil and capacitor.

In the fourth embodiment, the noise reduction member of the stator 181 prevents generation of electromagnetic noise according to the rotating drive of the direct-current motor. However, the electromagnetic compatibility (EMC) may be improved by removing noise of a current to be supplied to the armature coils or preventing generation of electromagnetic noise according to the rotating drive of the direct-current motor. Therefore, for example, as a noise reduction member, a diode or a surge suppressor may be provided in the stator 181.

In the second through fourth embodiments, the pigtails 103a, 103b, and 153 may be in any shapes as long as they can press the power supply brushes 102, 106, and 133 to the advancing side in the rotation direction of the commutator 41 by their forces of restitution.

In the second through fourth embodiments, the ends of the pigtails 103a, 103b, and 153, on sides corresponding to the power supply brushes 102, 106, and 133 are connected to the side surfaces of the power supply brushes 102, 106, and 133 on the trailing side in the rotation direction of the commutator 41. However, these ends may be connected to any side surfaces of the power supply brushes 102, 106, and 133. In the second through fourth embodiments, the pigtails 103a, 103b, and 153 are disposed on the further trailing side in the rotation direction of the commutator 41 than the power supply brushes 102, 106, and 133, and this is allowed as long as they are disposed around the power supply brushes 102, 106, and 133.

In the above-described second embodiment, the opening in the axial direction of the insertion groove 95 of the second divided holder 82 is closed by the first divided holder 81. However, the opening does not need to be closed. In the third embodiment, the opening in the axial direction of the first insertion groove 143 formed in the first divided holder 141 is closed by the second divided holder 142, and the opening in the axial direction of the second insertion groove 151 formed in the second divided holder 142 is closed by the first divided holder 141. However, the opening in the axial direction of the first insertion groove 143 does not need to be closed by the second divided holder 142, and the opening in the axial direction of the second insertion groove 151 does not need to be closed by the first divided holder 141.

In the third embodiment, when manufacturing the stator 121, the brush holder 131 (brush assembly 123) is assembled to the stator housing 122 after the coil springs 134 are inserted in the axial direction into the insides of the first divided holders 141 and the caps 132 are attached to the first divided holders 141. However, the second divided holders 142 into which the power supply brushes 133 have been inserted and the first divided holders 141 may be assembled to each other in the axial direction to form brush holders 131, and the coil springs 134 may be inserted into the brush holders 131 and the caps 132 are attached to the brush holders 131 after the brush holders 131 are inserted into the attaching holes 122a of the stator housing 122. In this case, the coil springs 134 are inserted into the brush holders 131 and the caps 132 are attached to the brush holders 131 after the stator housing 122 to which the field assembly 64, the brush holders 131, and the terminal assembly 124 have been assembled is assembled to the rotor 3. As a result, when the power supply brushes 133 and the sliding contact surfaces 42a of the commutator 41 come into contact with each other, the urging forces of the coil springs 134 are not applied to the power supply brushes 133, so that the power supply brushes 133 are prevented from being broken during manufacturing of the stator 121.

In the above-described third embodiment, the two terminals 162 and 163 are formed into an assembly by being assembled to the holding member 161. However, the holding member 161 may be omitted, and the two terminals 162 and 163 may be disposed with respect to the stator housing 122.

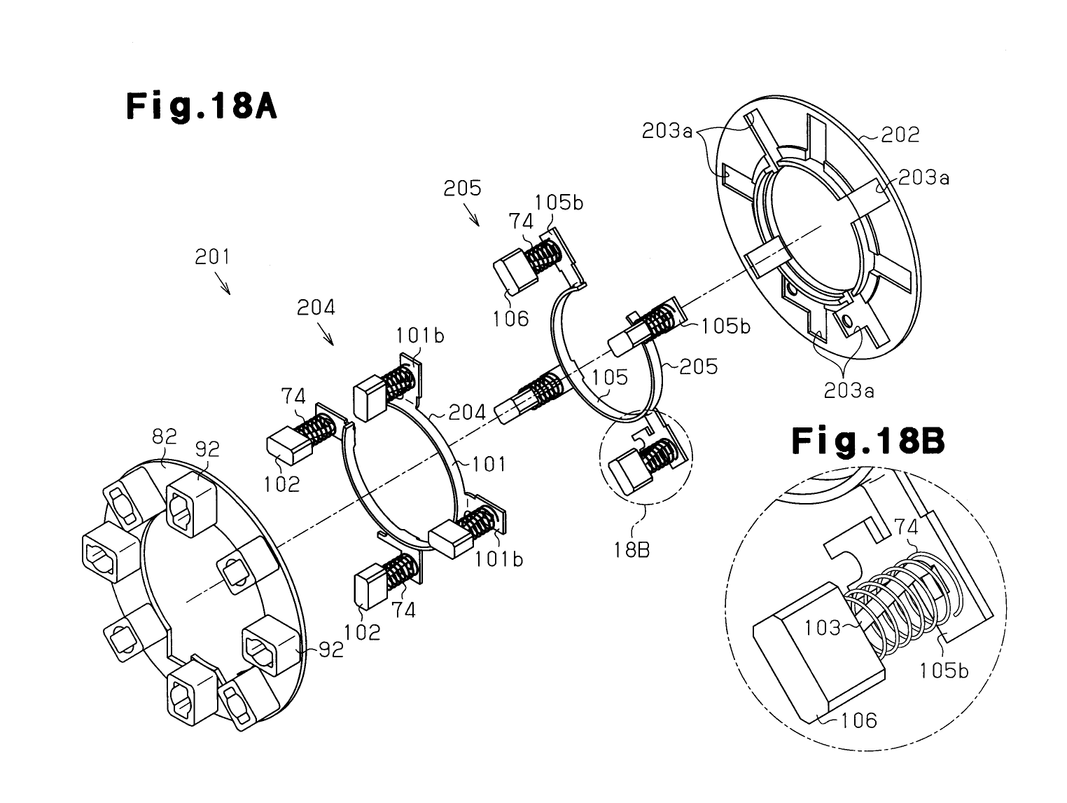

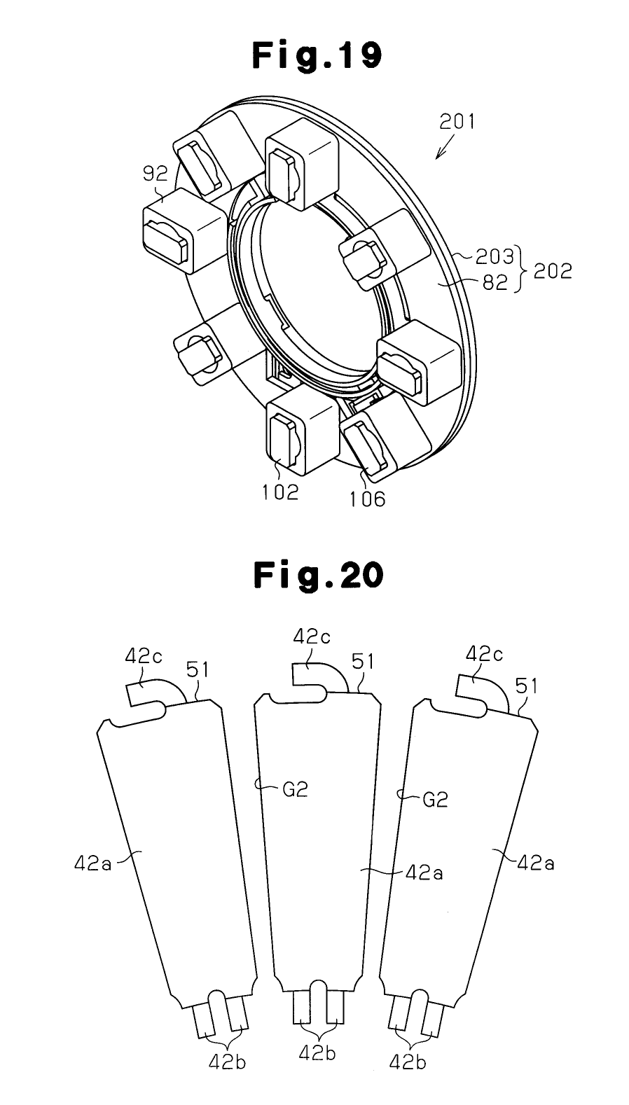

Instead of the brush assembly 63 of the second embodiment, a brush assembly 201 shown in FIG. 18A and FIG. 19 may be provided in the direct-current motor 61.

A brush holder 202 constituting the brush assembly 201 includes a first divided holder 203 and a second divided holder 82 to be assembled to each other in the axial direction. In an anode brush assembly 204, coil springs 74 are disposed between connecting pieces 101b extended to the radially outside of the anode terminal 101 and anode power supply brushes 102. Pigtails 103 are disposed inside the coil springs 74 and both ends thereof are connected to the connecting pieces 101b and the anode power supply brushes 102, respectively. Similarly, in the cathode brush assembly 205, coil springs 74 are disposed between connecting pieces 105b extended to the radially outside of the cathode terminal 105 and cathode power supply brushes 106. Pigtails 103 are disposed inside the coil springs 74 and both ends thereof are connected to the connecting pieces 105b and the cathode power supply brushes 106, respectively (see FIG. 18B). On the first divided holder 203, eight positioning recesses 203a shaped corresponding to the connecting pieces 101b and 105b are formed. The anode brush assembly 204 and cathode brush assembly 205 are sandwiched from both sides in the axial direction by the first divided holder 203 and the second divided holder 82 so that the connecting pieces 101b and 105b are housed within the positioning recesses 203a. As a result, the anode brush assembly 204 and the cathode brush assembly 205 are positioned in the circumferential direction. By adjusting the lengths of the pigtails 103a and 103b, the protruding amounts of the power supply brushes 102 and 106 from the brush holding parts 92 before being assembled to the rotor 3 can be easily adjusted. The wearing amounts of the power supply brushes 102 and 106 are made constant, and short-circuiting between the segments 42 and the pigtails 103a and 103b is prevented.

In the second through fourth embodiments, the brush holder 71, 131 is formed of two parts, that is, first divided holder 81, 141 and the second divided holder 82, 142 to be assembled to each other in the axial direction. However, the brush holder 71, 131 may be formed of three or more parts as long as the parts are assembled to each other in the axial direction.

In the second embodiment, the first divided holder 81 constituting the brush holder 71 and the stator housing 11 may be integrally molded from an insulating synthetic resin material. In this case, the number of parts constituting the stator 62 is reduced.

In the above-described embodiments, the gap G1 between segments 42 circumferentially adjacent to each other is constant at any position in the radial direction. However, the gap between the segments circumferentially adjacent to each other may be set as shown in FIG. 20. In FIG. 20, the gap G2 between the segments 51 circumferentially adjacent to each other becomes wider in circumferential width toward the radially outer end. Accordingly, powder produced due to wearing of the power supply brushes 19 more easily comes to the outer periphery due to a centrifugal force applied by the rotation of the rotor 3. As a result, short-circuiting between the segments 51 circumferentially adjacent to each other due to the powder produced according to wearing of the power supply brushes 19 is suppressed.

In the above-described embodiments, the rotor housing 31 has a support 31c which supports the rotary shaft 32. This support 31c may be formed so as to entirely protrude to the inside of the rotor housing 31, or on the contrary, to entirely protrude to the outside of the rotor housing 31. Even in this case, the supporting force of the rotary shaft 32 in the rotor housing 31 is made great. The support 31c may be omitted. The insertion recess 14b formed in the field core 14 may be omitted.

The power supply brushes 19, 102, 106, and 133 are at least partially disposed at positions that come into sliding contact with the sliding contact surface 42a of the segments 42 at the further radially outward than the armature coils 34. Thereby, the same advantage as (1) of the first embodiment is obtained. For example, the power supply brushes 19, 102, 106, and 133 of the respective embodiments may be disposed at further radially outward than the positions in the embodiments.

The core fixing portion 31a and the bottom portion 31b are formed integrally in the respective embodiments. However, they may be provided separately.

In the respective embodiments, the commutator 41 is fixed to the opening 31e of the rotor housing 31 via the fixing member 35. However, the commutator 41 may be directly connected to the opening 31e of the rotor housing 31. Also, the commutator 41 may be fixed to the opening 31e of the rotor housing 31 by molding the portions except for the sliding contact surfaces 42a of the rotor 3 with an insulating resin.

The direct-current motors 1 and 61 of the respective embodiments include an armature core 33 having thirty-two teeth 33b, eight permanent magnets 16, and thirty-two segments 42. However, the number of teeth 33b, the number of permanent magnets 16, the number of segments 42, and the numbers of power supply brushes 19, 102, 106, and 133 may be changed as necessary. The winding of the armature coils 34 around the armature core 33 is not limited to the distributed winding, but may be concentrated winding.

What is claimed is:

1. A direct-current motor comprising:
a stator having a magnetic field system;
a rotor disposed around the stator, wherein the rotor includes an armature core around which armature coils are wound, and a rotary shaft which rotates together with the armature core;
a commutator which rotates together with the rotor, wherein the commutator has a plurality of segments extending radially, and the segments have sliding contact surfaces orthogonal to an axial line of the rotary shaft; and
a plurality of power supply brushes which are urged in the axial direction by urging members so as to come into contact with the sliding contact surfaces, wherein at least a part of each power supply brush comes into contact with the sliding contact surface at a position further radially outward than the armature coil.

2. The direct-current motor according to claim 1, wherein the rotor has a cylindrical rotor housing having a bottom portion, and a cylindrical support which protrudes in the axial direction toward the inside of the rotor housing is provided at the bottom portion center of the rotor housing, and the support supports the rotary shaft such that the rotary shaft rotates integrally with the rotor housing, and
wherein the stator has a cylindrical field core, the magnetic field system is fixed to the outer periphery of the field core, and the field core has an end facing the bottom portion in the axial direction, and the end has an insertion recess into which the support is inserted.

3. The direct-current motor according to claim 1, wherein a circumferential width of a gap between each circumferentially adjacent pair of the segments becomes wider toward the radially outer periphery.

4. The direct-current motor according to claim 1, wherein the inner diameter of the commutator is larger than the outer diameter of the magnetic field system.

5. The direct-current motor according to claim 1, wherein the stator includes:
a stator housing;
a brush assembly which has the power supply brushes and is assembled in the axial direction to the stator housing; and
a field assembly which has a plurality of permanent magnets arranged along the circumferential direction so as to form the magnetic field system, and is assembled in the axial direction to the stator housing at a position radially inside the brush assembly.

6. The direct-current motor according to claim 5, wherein the brush assembly has a brush holder including a first divided holder and a second divided holder assembled to each other in the axial direction, and the brush holder is assembled in the axial direction to the stator housing, and the power supply brushes are inserted into the brush holder from the axial direction, and
wherein the urging members are inserted into the inside of at least either of the first divided holder or the second divided holder, and urges the power supply brushes toward the sliding contact surfaces.

7. The direct-current motor according to claim 6, wherein the power supply brushes include anode brushes and cathode brushes, and the brush assembly includes:
an anode brush assembly which connects the anode brushes to an anode terminal via pigtails; and
a cathode brush assembly which connects the cathode brushes to a cathode terminal via pigtails,
wherein the first divided holder and the second divided holder are ring-shaped, and hold the anode brush assembly and the cathode brush assembly from both sides in the axial direction.

8. The direct-current motor according to claim 6, wherein the number of the brush assemblies is equal to the number of the power supply brushes, and each brush assembly has one brush holder, one power supply brush, and one urging member, and the stator includes:
two terminals to which the power supply brushes are connected via the pigtails;
a holding member which maintains the positions of the terminals constantly with respect to each other; and
a terminal assembly to be assembled in the axial direction to the stator housing, wherein the terminal assembly is disposed radially inside of the brush assemblies.

9. The direct-current motor according to claim 7, wherein at least one of the first divided holder and the second divided holder has an insertion groove opened in the axial direction through which the pigtails are inserted, and the opening of the insertion groove is closed by the other divided holder.

10. The direct-current motor according to claim 7, wherein the urging members are coil springs each disposed between a connecting piece formed integrally with the corresponding terminal and the corresponding power supply brush, each pigtail is inserted into one of the coil springs, and each pigtail has both ends which are connected to the corresponding connecting piece and the corresponding power supply brush, respectively.

11. The direct-current motor according to claim 7, wherein each pigtail has an end which is connected to a side surface of the corresponding power supply brush positioned on the trailing side in the rotation direction of the commutator, and disposed on the further trailing side in the rotation direction of the commutator than the power supply brush.

12. The direct-current motor according to claim 11, wherein each pigtail is in a curved shape when viewed from the axial direction of the rotary shaft, and the pigtail applies a force of restitution to press the corresponding power supply brush to the advancing side in the rotation direction of the commutator.

13. The direct-current motor according to claim 11, wherein each pigtail is in a curved shape when viewed from the radial direction of the rotary shaft, and the pigtail applies a force of restitution to press the corresponding power supply brush to the advancing side in the rotation direction of the commutator.

14. The direct-current motor according to claim 5, further comprising a noise reduction member which improves electromagnetic compatibility.

15. The direct-current motor according to claim 14, wherein the field assembly includes:
a cylindrical support member which extends along the axial direction, wherein the permanent magnets are disposed along the circumferential direction on the outer periphery of the support member; and
a bearing which supports the rotary shaft, wherein the bearing is disposed on an end of the support member on a side corresponding to the stator housing so as to be spaced in the axial direction from the permanent magnets,
wherein the noise reduction member is disposed on an outer periphery of a portion between the permanent magnets and the bearing in the support member.

16. The direct-current motor according to claim 15, wherein the noise reduction member is disposed on the further radially inward than the side surfaces that are radially outside the permanent magnets.

17. The direct-current motor according to claim 16, wherein the inner diameter of the commutator is larger than the outer diameter of the magnetic field system.

18. A manufacturing method for a direct-current motor comprising:
a stator having a magnetic field system;
a rotor disposed around the stator, wherein the rotor includes an armature core around which armature coils are wound, and a rotary shaft which rotates together with the armature core;
a commutator which rotates together with the rotor, wherein the commutator has a plurality of segments extending radially, and the segments have sliding contact surfaces orthogonal to an axial line of the rotary shaft; and
a plurality of power supply brushes which are urged in the axial direction by urging members so as to come into contact with the sliding contact surfaces, the method comprising:
disposing the power supply brushes at further radially outer positions than the magnetic field system such that the power supply brushes are urged in the axial direction by the urging members;
fixing the armature core around which the armature coils are wound to the inside of a cylindrical rotor housing having a bottom portion;
fixing the rotary shaft to the bottom portion of the rotor housing;
fixing the commutator to an opening of the rotor housing such that the sliding contact surfaces are directed in a direction opposite to the armature coils; and
assembling the rotor and the stator to each other by moving one of the rotor and the stator with respect to the other along the axial direction and inserting the magnetic field system into the inside of the rotor housing from the opening of the rotor housing, such that at least a part of each power supply brush comes into contact with the sliding contact surface at a position further radially outward than the armature coils.

19. The manufacturing method for a direct-current motor according to claim 18, wherein the stator includes a stator housing, a brush assembly having the power supply brushes, and a field assembly having a plurality of permanent magnets disposed along the circumferential direction so as to form the magnetic field system, and
wherein the brush assembly and the field assembly are assembled in the axial direction to the stator housing.

20. The manufacturing method for a direct-current motor according to claim 19, wherein the brush assembly has brush holders for holding the power supply brushes, and each brush holder includes a first divided holder and a second divided holder assembled to each other in the axial direction, and the urging members are disposed inside the brush holders and urge the power supply brushes to the sliding contact surfaces, the method further comprising:
assembling the first divided holder and the second divided holder to each other in the axial direction after the power supply brushes are inserted into either one of the first divided holder or the second divided holder from the axial direction, and
inserting the urging member into at least one of the first divided holder and the second divided holder from the axial direction.

21. The manufacturing method for a direct-current motor according to claim 20, wherein the power supply brushes include anode brushes and cathode brushes, and wherein the brush assembly includes:
an anode brush assembly which connects the anode brushes to an anode terminal via pigtails; and
a cathode brush assembly which connects the cathode brushes to a cathode terminal via pigtails,
wherein the first divided holder and the second divided holder are in annular shapes, and
wherein, after the power supply brushes are inserted into either one of the first divided holder or the second divided holder from the axial direction, the first divided holder and the second divided holder are assembled to each other in the axial direction so as to hold the anode brush assembly and the cathode brush assembly from both sides in the axial direction.

22. The manufacturing method for a direct-current motor according to claim 20, further comprising:
forming a terminal assembly by assembling two terminals, to which the power supply brushes are connected via pigtails, to a holding member which maintains the positions of these terminals constantly with respect to each other;
assembling the first divided holder and the second divided holder in the axial direction after the power supply brushes are inserted into either of the first divided holders, the number of which is equal to the number of power supply brushes, or the second divided holders, the number of which is equal to the number of power supply brushes, from the axial direction; and
assembling the brush assemblies, the number of which is equal to the number of power supply brushes, and the terminal assembly to the stator housing in the axial direction.
